(19) United States
(12) Patent Application Publication
(10) Pub. No.: US 2025/0127368 A1
(43) Pub. Date: Apr. 24, 2025

(54) ROBOT CLEANER STATION AND ROBOT CLEANER SYSTEM WITH THE SAME

(71) Applicant: SAMSUNG ELECTRONICS CO., LTD., Suwon-si (KR)

(72) Inventors: Heeseung CHOI, Suwon-si (KR); Yongdae Ko, Suwon-si (KR); Jinho Kim, Suwon-si (KR); Sungman Park, Suwon-si (KR); Hyungmin Son, Suwon-si (KR); Jinho Choi, Suwon-si (KR)

(73) Assignee: SAMSUNG ELECTRONICS CO., LTD., Suwon-si (KR)

(21) Appl. No.: 18/972,150

(22) Filed: Dec. 6, 2024

Related U.S. Application Data
(63) Continuation of application No. PCT/KR2024/014516, filed on Sep. 25, 2024.

(30) Foreign Application Priority Data
Oct. 18, 2023 (KR) 10-2023-0139866

(51) Int. Cl. A47L 11/40; A47L 9/00; B08B 13/00

(52) U.S. Cl. CPC A47L 11/4091; A47L 9/0063; B08B 13/00; A47L 2201/028

(57) ABSTRACT

A robot cleaner station includes: a base; a pad cleaner provided in an upper surface of the base and configured to place and clean a mop pad; a pad moving device configured to move a used mop pad from the pad cleaner and place a cleaned mop pad on the pad cleaner; and one or more processors, where, by executing one or more instructions stored on at least one memory, the one or more processors are configured to: control the pad moving device to move the used mop pad to the pad cleaner, and control the pad cleaner to clean the used mop pad based on a robot cleaner obtaining the cleaned mop pad and moving away from the base.

CROSS-REFERENCE TO RELATED APPLICATION(S)

This application is a continuation application of International application No. PCT/KR2024/014516, filed on Sep. 25, 2024, which is based on and claims priority to Korean Patent Application number 10-2023-0139866, filed on Oct. 18, 2023, in the Korean Intellectual Property Office, the disclosures of which are incorporated by reference herein in their entireties.

### BACKGROUND

### 1. Field

The disclosure relates to a robot cleaner station, and more particularly, to a robot cleaner station capable of automatically changing mop pads and cleaning mop pads, and a robot cleaner system having the same.

### 2. Description of Related Art

With the advancement of technology, various types of robot cleaners are being sold on the market.

A typical robot cleaner may be designed to automatically drive the surface to be cleaned and collect dust or dirt on the surface to be cleaned by sucking it in.

Some robot cleaners may be equipped with a mopping function to mop the surface to be cleaned, but do not have a function to collect dust or dirt from the surface to be cleaned.

Some robot cleaners have both the function of collecting dust or dirt form the surface to be cleaned and the function of mopping the surface to be cleaned.

Some robot cleaners with a mopping function may be configured to allow a user to manually replace a used mop pad with a new mop pad.

Some robot cleaners with a mopping function may include a robot cleaner station with a cleaning device for cleaning the mop pad. When a robot cleaner with a used mop pad attached enters the cleaning device, the robot cleaner station cleans the used mop pad while it remains attached to the robot cleaner. When cleaning of the mop pad is completed, the robot cleaner leaves the robot cleaner station and mops the surface to be cleaned.

### SUMMARY

Aspects will be set forth in part in the description which follows and, in part, will be apparent from the description, or may be learned by practice of the presented embodiments.

According to an aspect of the disclosure, a robot cleaner station may include: a base; a pad cleaner provided in an upper surface of the base and configured to place and clean a mop pad; a pad moving device configured to move a used mop pad from the pad cleaner and place a cleaned mop pad on the pad cleaner; and one or more processors, where, by executing one or more instructions stored on at least one memory, the one or more processors are configured to: control the pad moving device to move the used mop pad to the pad cleaner, and control the pad cleaner to clean the used mop pad based on a robot cleaner obtaining the cleaned mop pad and moving away from the base.

The pad moving device may include: a lifting frame having a rectangular shape; a rotating plate rotatably provided within the lifting frame and to which the mop pad is fixed; a lifting device configured to move the lifting frame up and down; and a rotating device configured to rotate the rotating plate.

The rotating plate may include: a first surface; a second surface opposite to the first surface; a first holder locker on the first surface and configured to selectively hold the mop pad; and a second holder locker on the second surface and configured to selectively hold the mop pad.

The rotating device may include: a pair of protrusions respectively protruding from side surfaces of the rotating plate; a pair of interference levers respectively provided on sides of the lifting frame, wherein, based on the lifting frame moving up and one of the pair of interference levers interfering with one of the pair of protrusions, the rotating plate rotates at a certain angle with respect to the lifting frame; and two pairs of stop grooves respectively provided on the side surfaces of the lifting frame and configured to accommodate the pair of protrusions.

The lifting device may include: a pair of rack gears respectively provided on side surfaces of the lifting frame; a pair of pinions engaged with the pair of rack gears; a driving gear configured to drive the pair of pinions; a motor to configured to rotate the driving gear; and a pair of guiders configured to guide an up and down movement of the lifting frame.

The driving gear may include: a first driving gear and a second driving gear respectively engaged with the pair of pinions, and a connection shaft connecting the first driving gear and the second driving gear.

The pad moving device may include: a lifting plate having a rectangular shape and to which the mop pad is fixed; and a lifting device configured to move the lifting plate up and down.

The lifting device may include: a pair of rack gears respectively provided on side surfaces of the lifting plate; a pair of pinions engaged with the pair of rack gears; a driving gear configured to drive the pair of pinions; a motor configured to rotate the driving gear; and a pair of guiders configured to guide an up and down movement of the lifting plate.

The lifting plate may include a holder locker on a lower surface configured to selectively hold the mop pad.

The holder locker may include: a locking hole in a center thereof; and a plurality of ball springs provided at intervals on an inner circumferential surface of the locking hole.

The pad moving device may include: a pad holder configured to fix the mop pad; and a holder locker configured to selectively hold the pad holder, where the pad holder includes: a holder plate having a lower surface to which the mop pad is attached; and a fixing protrusion protruding from a center of an upper surface of the holder plate.

The holder locker may include: a locking hole at a center of the holder locker and into which the fixing protrusion of the pad holder is to be inserted; and a lock included in the locking hole and configured to selectively fix the fixing protrusion.

According to an aspect of the disclosure, a robot cleaner system may include: a robot cleaner configured to mop a surface using a cleaned mop pad; and a robot cleaner station configured to: supply the cleaned mop pad to the robot cleaner, replace, based on a mopping operation of the robot cleaner being completed such that the cleaned mop pad becomes a used mop pad, the used mop pad with a second cleaned mop pad, and clean the used mop pad based on the robot cleaner performing the mopping operation, where the robot cleaner station may include: a base; a pad cleaner provided in an upper surface of the base and configured to place the cleaned mop pad and clean the used mop pad; a pad moving device configured to move the used mop pad from the pad cleaner and place the cleaned mop pad on the pad cleaner; and one or more processors, where, by executing one or more instructions stored on at least one memory, the one or more processors are configured to: control the pad moving device to move the used mop pad to the pad cleaner, and control the pad cleaner to clean the used mop pad based on the robot cleaner obtaining the cleaned mop pad and leaving the base to perform the mopping operation.

The pad moving device may include: a lifting frame having a rectangular shape; a rotating plate rotatably provided within the lifting frame and configured to fix the used mop pad and the cleaned mop pad; a lifting device configured to move the lifting frame up and down; and a rotating device configured to rotate the rotating plate.

The pad moving device may include: a lifting plate having a rectangular shape and configured to fix the used mop pad; and a lifting device configured to move the lifting plate up and down.

The rotating device may include: a pair of protrusions respectively protruding from side surfaces of the rotating plate; a pair of interference levers respectively provided on both sides of the lifting frame, wherein, based on the lifting frame moving up and one of the pair of interference levers contacting one of the pair of protrusions, the rotating plate rotates at a certain angle with respect to the lifting frame; and two pairs of stop grooves respectively provided on the side surfaces of the lifting frame and configured to accommodate the pair of protrusions.

The robot cleaner system may further include a dryer on an upper side of the lifting frame configured to dry the cleaned mop pad.

According to an aspect of the disclosure, a robot cleaner system may include: a pad cleaner provided in an upper surface of a base and configured to place and clean a mop pad; a pad moving device configured to move a used mop pad to the pad cleaner, where the pad moving device includes: a lifting frame including a pair of interference levers respectively provided on side surfaces, and two pairs of stop grooves respectively provided on the side surfaces; and a rotating plate rotatably provided within the lifting frame and including a pair of protrusions respectively protruding from side surfaces thereof and corresponding to the two pairs of stop grooves of the lifting frame; and a lifting device configured to move the lifting frame up and down, where, based on the lifting frame being moved up and one of the pair of interference levers interfering with one of the pair of protrusions, the rotating plate rotates a certain angle with respect to the lifting frame, and based on the lifting frame being moved down, the rotating plate does not rotate.

The robot cleaner system may further include one or more processors, where, by executing one or more instructions stored on at least one memory, the one or more processors are configured to: control the pad moving device to move a used mop pad to the pad cleaner, and control the pad cleaner to clean the used mop pad.

The rotating plate may include: a first surface; a second surface opposite to the first surface; a first holder locker on the first surface and configured to selectively hold the mop pad; and a second holder locker on the second surface and configured to selectively hold the mop pad.

### BRIEF DESCRIPTION OF DRAWINGS

These and/or other aspects, features, and advantages of certain embodiments of the disclosure will be more apparent from the following description taken in conjunction with the accompanying drawings, in which:

FIG. 1 is a perspective view illustrating a robot cleaner station according to one or more embodiments of the disclosure;

FIG. 2 is a perspective view illustrating a robot cleaner station without a case according to one or more embodiments of the disclosure;

FIG. 3 is a cross-sectional view illustrating the robot cleaner station of FIG. 1 taken along line A-A according to one or more embodiments of the disclosure;

FIG. 4 is an exploded perspective view illustrating a lifting frame and a rotating plate of a pad moving device of a robot cleaner station according to one or more embodiments of the disclosure;

FIG. 5 is a cross-sectional view illustrating a rotating plate of a pad moving device according to one or more embodiments of the disclosure;

FIG. 6 is a perspective view illustrating an interference lever of a pad moving device according to one or more embodiments of the disclosure;

FIG. 7 is a perspective view illustrating a mop pad assembly used in a robot cleaner station according to one or more embodiments of the disclosure;

FIG. 8 is a cross-sectional view illustrating the mop pad assembly of FIG. 7 according to one or more embodiments of the disclosure;

FIG. 9 is a perspective view illustrating a mop pad of the mop pad assembly of FIG. 7 according to one or more embodiments of the disclosure;

FIG. 10 is a bottom perspective view illustrating a pad holder of the mop pad assembly of FIG. 7 according to one or more embodiments of the disclosure;

FIG. 11 is a cross-sectional view illustrating a rotating plate of a robot cleaner station according to one or more embodiments of the disclosure to which a mop pad is coupled;

FIG. 12 is a cross-sectional view illustrating a pad holder coupled to a holder locker of a robot cleaner station according to one or more embodiments of the disclosure;

FIG. 13 is a cross-sectional view illustrating the pad holder separated from the holder locker of FIG. 12 according to one or more embodiments of the disclosure;

FIG. 14 is a view illustrating a robot cleaner system according to one or more embodiments of the disclosure;

FIG. 15 is a block diagram of a robot cleaner system according to one or more embodiments of the disclosure;

FIG. 16A, FIG. 16B, FIG. 16C, FIG. 16D, FIG. 16E, FIG. 16F, FIG. 16G, and FIG. 16H are views for explaining a method of replacing a mop pad using a robot cleaner system according to one or more embodiments of the disclosure;

FIG. 17 is a perspective view illustrating a robot cleaner station according to one or more embodiments of the disclosure;

FIG. 18 is a bottom perspective view illustrating a lifting plate of the robot cleaner station of FIG. 17 according to one or more embodiments of the disclosure;

FIG. 19 is a cross-sectional perspective view illustrating a stacked state of two mop pad assemblies used in a robot cleaner station according to one or more embodiments of the disclosure;

FIG. 20 is a cross-sectional view illustrating a state in which a pad holder of a mop pad assembly is coupled to a holder locker of a lifting plate of a robot cleaner station according to one or more embodiments of the disclosure;

FIG. 21A, FIG. 21B, FIG. 21C, FIG. 21D, FIG. 21E, and FIG. 21F are views for explaining a method of replacing a mop pad using a robot cleaner system according to one or more embodiments of the disclosure.

### DETAILED DESCRIPTION

Various embodiments of this document and terms used herein are not intended to limit the technical features described in this document to specific embodiments, but should be understood to include various modifications, equivalents, or alternatives of the embodiments. The embodiments described herein are example embodiments, and thus, the disclosure is not limited thereto and may be realized in various other forms.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, it means that the one component can be connected to the another component directly (e.g., wired), wirelessly, or through a third component.

Terms such as “comprise,” “include,” “have” and the like are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure relates to a robot cleaner station capable of replacing a used mop pad mounted on a robot cleaner with a cleaned mop pad and cleaning the used mop pad while the robot cleaner performs mopping using the cleaned mop pad. In addition, the disclosure relates to a robot cleaner system including the robot cleaner station and the robot cleaner described above.

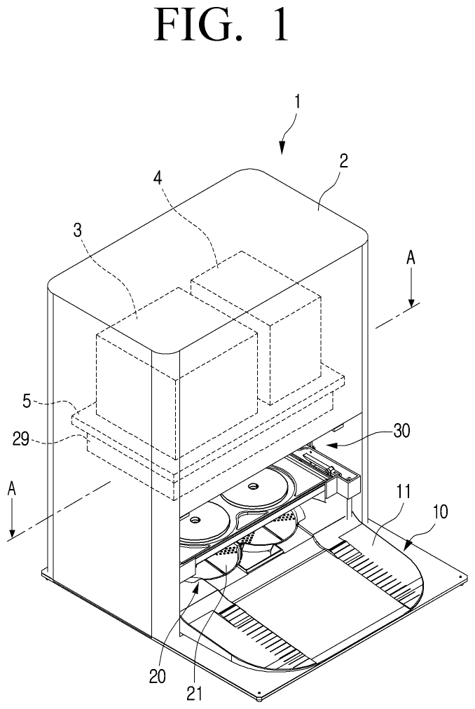

Hereinafter, a robot cleaner station 1 according to one or more embodiments of the disclosure will be described in detail with reference to FIG. 1 attached.

FIG. 1 is a perspective view illustrating a robot cleaner station 1 according to one or more embodiments of the disclosure.

Referring to FIG. 1, a robot cleaner station 1 according to one or more embodiments of the disclosure may include a base 10, a pad cleaner 20, and a pad moving device 30.

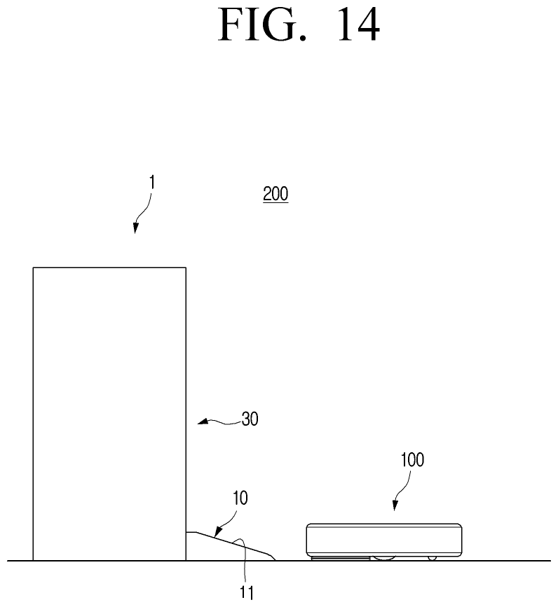

The base 10 is formed to support the robot cleaner station 1. Accordingly, the robot cleaner station 1 may be disposed on the installation surface by the base 10. Here, the installation surface may be a surface to be cleaned on which a robot cleaner 100 (see FIG. 14) moves.

The base 10 may include an access road 11 through which the robot cleaner 100 comes up to the upper surface of the base 10. The access road 11 may be formed as a slope.

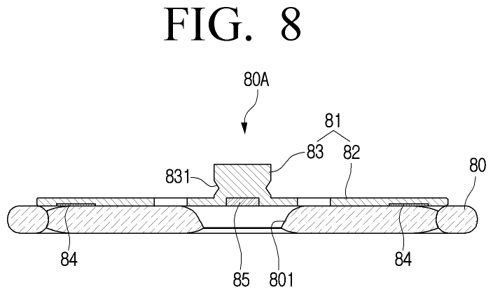

The pad cleaner 20 may be disposed in the upper surface of the base 10. The pad cleaner 20 is configured to clean a mop pad 80 (see FIG. 8). The pad cleaner 20 is configured to clean the lower surface of the mop pad 80 supported by the pad moving device 30.

The pad cleaner 20 is configured to place the mop pad 80 thereon. The pad cleaner 20 may include a pad seat 21 on which the mop pad 80 is placed. The pad seat 21 is configured to be able to move a certain distance in a direction perpendicular to the upper surface of the base 10. In the case of this embodiment, the pad cleaner 20 includes two pad seats 21 to place two mop pads 80.

When the robot cleaner 100 enters the inside of the robot cleaner station 1 along the access road 11, a mopping device provided on the lower surface of the robot cleaner 100 may face the pad cleaner 20 disposed on the base 10. The robot cleaner 100 may place the used mop pad 80′ on the pad seat 21 of the pad cleaner 20.

The pad moving device 30 is configured to move the used mop pad 80′ placed on the pad cleaner 20. In detail, the pad moving device 30 may be configured to pick up the mop pad 80 placed on the pad cleaner 20 and move it upward to a height higher than the height of the robot cleaner 100.

The pad moving device 30 may be configured to place the cleaned mop pad 80 on the pad cleaner 20. In detail, the pad moving device 30 is configured so that the pad moving device 30 supports the used mop pad 80′ to allow the pad cleaner 20 to clean the used mop pad 80′, and moves the cleaned mop pad 80 to a location separated by a certain distance above the pad cleaner 20. The pad moving device 30 may position the cleaned mop pad 80 in the pad seat 21 of the pad cleaner 20.

In the case of this embodiment, the pad moving device 30 is configured to move two mop pads 80 at once. However, this is only an example, and the pad moving device 30 may be configured to move the mop pads 80 corresponding to the number of mop pads 80 attached to the robot cleaner 100 at once. For example, the pad moving device 30 may be configured to move one mop pad 80 or three or more mop pads 80 at a time.

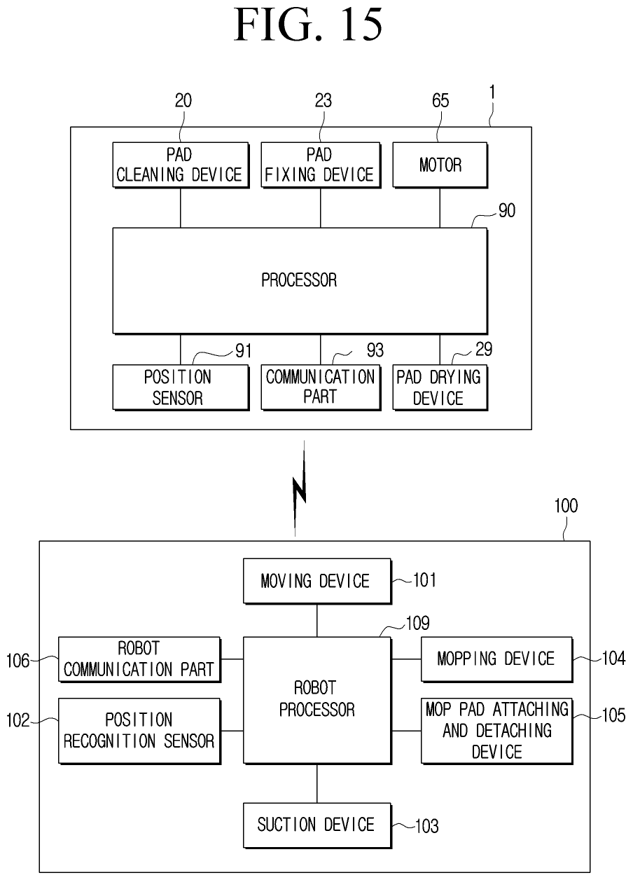

The pad moving device 30 and the pad cleaner 20 may be controlled by a processor 90 (see FIG. 15). The processor 90 may be configured to control the pad moving device 30 so that the pad moving device 30 moves the mop pad 80. The processor 90 may be configured to control the pad cleaner 20 so that the pad cleaner 20 cleans the mop pad 80 moved by the pad moving device 30.

A processor 90 according to embodiments of the present disclosure may include one or more processors. The one or more processors may include one or more of a central processing unit (CPU), a many integrated core (MIC), a field-programmable gate array (FPGA), a digital signal processor (DSP), a hardware accelerator, etc. The one or more processors are able to perform control of any one or any combination of the other components of the pad cleaner 20 and/or the pad moving device 30, and/or perform an operation or data processing relating to communication. The one or more processors execute one or more programs stored in at least one memory.

For example, when the robot cleaner 100 mounts the cleaned mop pad 80 placed on the pad cleaner 20 and moves away from the base 10, the processor 90 may control the pad moving device 30 to move the used mop pad 80′ to the pad cleaner 20, and then may control the pad cleaner 20 to clean the used mop pad 80′. In other words, the processor 90 may control the pad cleaner 20 to clean the mop pad 80 while the pad moving device 30 positions and supports the mop pad 80 on the pad cleaner 20.

The processor 90 may be configured to dry the cleaned mop pad 80 using a pad drying device 29.

The robot cleaner station 1 may include a case 2. The case is formed to accommodate and support the base 10, the pad cleaner 20, and the pad moving device 30.

An entrance through which the robot cleaner 100 enters may be provided at the front surface of the case 2. The robot cleaner 100 may come up to the upper surface of the base 10 through the entrance of the case 2.

The robot cleaner station 1 may include the pad drying device 29. The pad drying device 29 may be configured to dry the mop pad 80 cleaned by the pad cleaner 20. For example, the pad drying device 29 may include at least one fan.

The pad drying device 29 may be disposed in the case 2 above the pad moving device 30. When the mop pad 80 is moved upward by the pad moving device 30 and positioned below the pad drying device 29, the pad drying device 29 may dry the mop pad 80 fixed to the pad moving device 30.

The robot cleaner station 1 may include a fresh water container 3 and a dust container 4. The fresh water container 3 and dust container 4 may be disposed on the upper side of the pad drying device 29. An intermediate plate 5 supporting the fresh water container 3 and the dust container 4 may be disposed on the upper side of the pad drying device 29. The pad drying device 29 may be disposed below the intermediate plate 5.

The fresh water container 3 is configured to supply water to the robot cleaner 100 located on the upper surface of the base 10. The dust container 4 is configured to collect dust and dirt collected in the robot cleaner 100 located on the upper surface of the base 10.

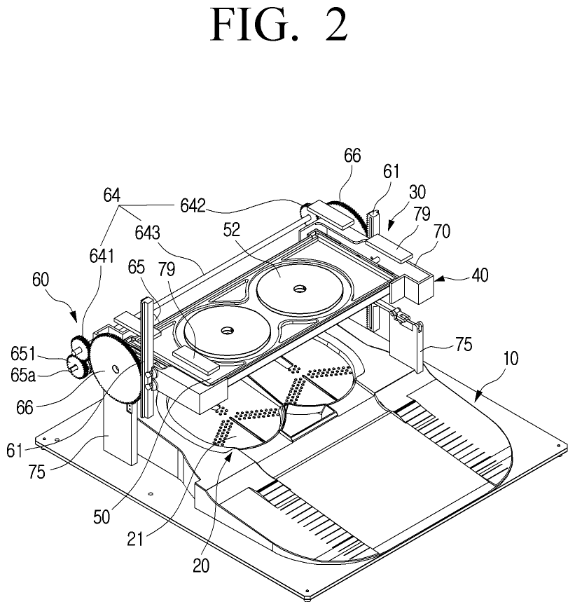

Hereinafter, the pad moving device 30 of the robot cleaner station 1 according to one or more embodiments of the disclosure will be described in detail with reference to FIGS. 2, 3, 4, 5, and 6 attached.

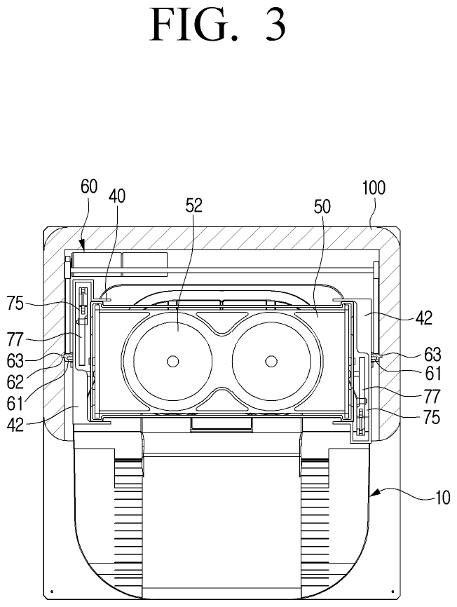

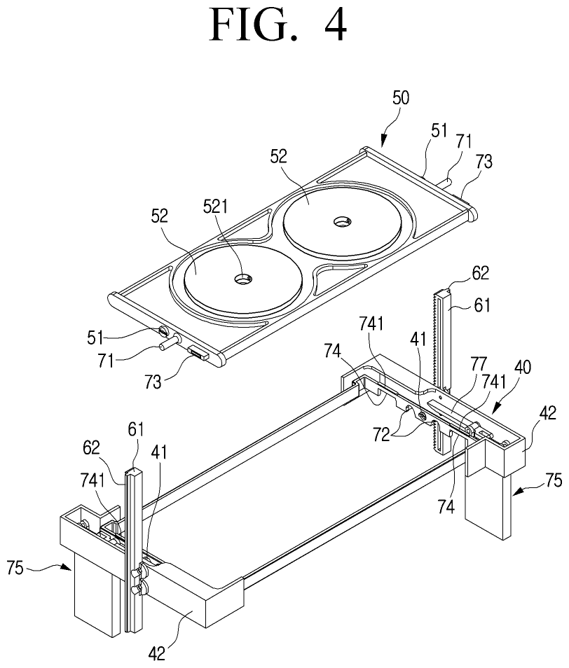

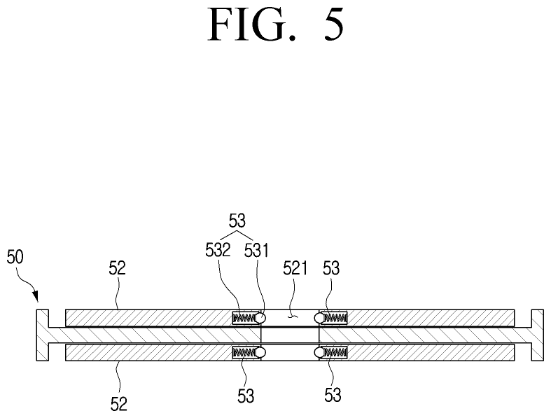

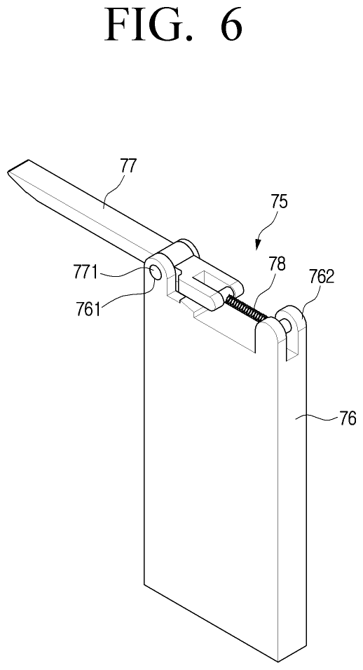

FIG. 2 is a perspective view illustrating a robot cleaner station 1 without a case 2 according to one or more embodiments of the disclosure. FIG. 3 is a cross-sectional view illustrating the robot cleaner station 1 of FIG. 1 taken along ling A-A. FIG. 4 is an exploded perspective view illustrating a lifting frame 40 and a rotating plate of a pad moving device 30 of a robot cleaner station 1 according to one or more embodiments of the disclosure. FIG. 5 is a cross-sectional view illustrating a rotating plate of a pad moving device 30 according to one or more embodiments of the disclosure. FIG. 6 is a perspective view illustrating an interference lever 75 of a pad moving device 30 according to one or more embodiments of the disclosure.

Referring to FIGS. 2, 3, 4, 5, and 6, the pad moving device 30 according to one or more embodiments of the disclosure may include a lifting frame 40, a rotating plate 50, a lifting device 60, and a rotating device 70.

The lifting frame 40 may be formed in a rectangular shape. The lifting frame 40 may be formed in the shape of a rectangular window frame with an empty interior. The lifting frame 40 is formed to support the rotation of the rotating plate 50. The lifting frame 40 is configured to be able to move up and down by the lifting device 60.

The rotating plate 50 may be formed in a substantially rectangular flat plate shape. The rotating plate 50 may be rotatably disposed inside the lifting frame 40. The rotating plate 50 is formed to support and fix the mop pad 80. In the case of this embodiment, the rotating plate 50 is formed to support and fix the two mop pads 80.

The rotating plate 50 may include a pair of rotating shafts 51. The pair of rotating shafts 51 may be disposed at the centers of the left and right side surfaces of the rotating plate 50, respectively. By supporting the pair of rotating shafts 51, the rotating plate 50 may be maintained in a horizontal state.

The lifting frame 40 may include a pair of shaft holes 41 corresponding to the pair of rotating shafts 51 of the rotating plate 50. The pair of shaft holes 41 may be formed on both side surfaces of the lifting frame 40, that is, on the left and right side surfaces of the lifting frame 40. The pair of rotating shafts 51 of the rotating plate 50 may be inserted into the pair of shaft holes 41 of the lifting frame 40, respectively. Accordingly, the rotating plate 50 may rotate with respect to the lifting frame 40.

When no external force is applied to the rotating plate 50, the rotating plate 50 may be disposed to remain parallel to the lifting frame 40.

The rotating plate 50 may include a holder locker 52. The holder locker 52 may be disposed on each of the first and second surfaces of the rotating plate 50. Here, the second surface of the rotating plate 50 refers to the surface opposite to the first surface. Hereinafter, the holder locker 52 disposed on the first surface of the rotating plate 50 is referred to as a first holder locker, and the holder locker 52 disposed on the second surface of the rotating plate 50 is referred to as a second holder locker.

The rotating plate 50 according to this embodiment has two first holder lockers 52 disposed on the first surface and two second holder lockers 52 disposed on the second surface so as to be able to pick up two mop pads 80 at a time. Because the first holder locker 52 and the second holder locker 52 are formed as the same structure, one holder locker 52 will be described below.

The holder locker 52 is configured to support and secure the mop pad 80. The holder locker 52 may be configured to selectively hold or release the mop pad 80. When the mop pad 80 is fixed to the pad holder 81 as in this embodiment, the holder locker 52 may be configured to selectively hold or release the pad holder 81.

The holder locker 52 may be formed in a disk shape. A locking hole 521 may be formed in the center of the holder locker 52. The locking hole 521 may be formed so that a fixing protrusion 83 of the pad holder 81 is inserted thereinto.

The holder locker 52 may include a locking part (e.g., a lock) configured to selectively fix the fixing protrusion 83 of the pad holder 81. The locking part may be disposed in the locking hole 521 of the holder locker 52. The locking part may be formed in various structures as long as it can secure the fixing protrusion 83 of the pad holder 81.

For example, the locking part may be formed as a plurality of ball springs 53. Each of the plurality of ball springs 53 may include a ball 531 and a coil spring 532 supporting the ball 531. The plurality of ball springs 53 may be disposed at regular intervals in the inner circumferential surface of the locking hole 521 of the holder locker 52.

A plurality of ball spring holes in which the plurality of ball springs 53 are disposed may be formed on the inner circumferential surface of the locking hole 521. Accordingly, when the plurality of ball springs 53 are disposed in the plurality of ball spring holes of the holder locker 52, the plurality of ball 531 may protrude from the inner circumferential surface of the locking hole 521. Each ball 531 of the plurality of ball springs 53 may move in the radial direction of the locking hole 521. Accordingly, the plurality of ball springs 53 may fix the fixing protrusion 83 of the pad holder 81 inserted into the locking hole 521.

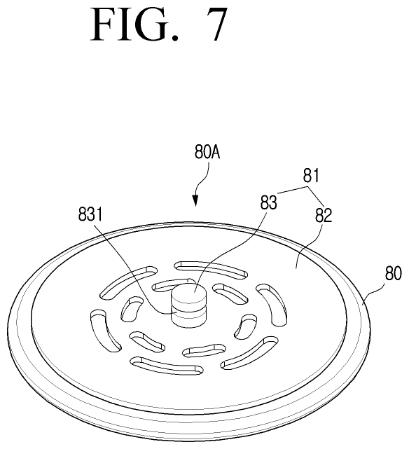

The mop pad 80 and the pad holder 81 may form a mop pad assembly 80A. Hereinafter, with reference to FIGS. 7, 8, 9, and 10, the mop pad assembly 80A used in the robot cleaner station 1 according to one or more embodiments of the disclosure will be described in detail.

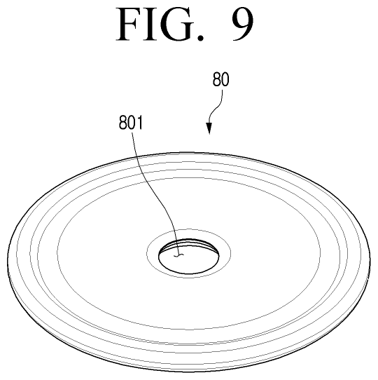

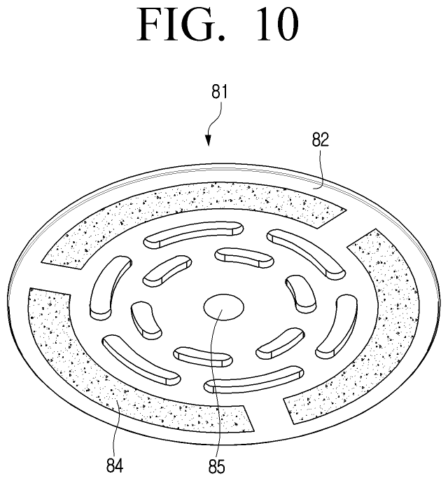

FIG. 7 is a perspective view illustrating a mop pad assembly 80A used in a robot cleaner station 1 according to one or more embodiments of the disclosure. FIG. 8 is a cross-sectional view illustrating the mop pad assembly 80A of FIG. 7. FIG. 9 is a perspective view illustrating a mop pad 80 of the mop pad assembly 80A of the FIG. 7. FIG. 10 is a bottom perspective view illustrating a pad holder 81 of the mop pad assembly 80A of FIG. 7.

Referring to FIGS. 7 and 8, the mop pad assembly 80A according to one or more embodiments of the disclosure includes a pad holder 81 and a mop pad 80.

The mop pad 80 may be fixed to the lower surface of the pad holder 81. The mop pad 80 may be detachably fixed to the lower surface of the pad holder 81. For example, the mop pad 80 may be attached to the lower surface of the pad holder 81 with Velcro.

Referring to FIG. 9, the mop pad 80 may be formed to have a substantially disk shape. A mop hole 801 may be formed in the center of the mop pad 80. The mop hole 801 may be formed to penetrate the mop pad 80 vertically.

One surface of the mop pad 80 is formed as a mop surface for mopping the surface to be cleaned, and the opposite surface thereof may be formed as a detachable surface that is attached to and detached form the lower surface of the pad holder 81. The detachable surface may be formed to be attached to Velcro. The mop pads 80 may be attached to or detached from the mopping device of the robot cleaner 100 using the detachable surface.

Here, the mop pad 80 whose mop surface is dirty is referred to as a used mop pad 80′, and the mop pad 80 whose mop surface is cleaned by the pad cleaner 20 is referred to as a cleaned mop pad 80. That is, when the used mop pad 80′ is cleaned by the pad cleaner 20, it becomes a cleaned mop pad 80.

Referring to FIGS. 7 and 8, the pad holder 81 may include a holder plate 82 and a fixing protrusion 83.

The holder plate 82 may be formed so that the mop pad 80 is attached to the lower surface of the holder plate 82. The holder plate 82 may be formed in a shape corresponding to the mop pad 80. For example, the holder plate 82 may be formed in a disk shape. The holder plate 82 may be formed to have a diameter smaller than or similar to that of the mop pad 80.

A separation magnet 85 may be disposed at the center of the holder plate 82. The separation magnet 85 may be formed of a permanent magnet. The separation magnet 85 may be used to separate the pad holder 81 from the holder locker 52 of the rotating plate 50.

A plurality of Velcro 84 may be disposed on the lower surface of the holder plate 82 at regular intervals. The plurality of Velcro 84 may be arranged in a circular around the separation magnet 85. Because the detachable surface is provided on the upper surface of the mop pad 80, the mop pad 80 may be fixed or attached to the lower surface of the holder plate 82 with the plurality of Velcro 84. When the mop pad 80 is attached to the lower surface of the holder plate 82, the mop pad assembly 80A is formed.

The fixing protrusion 83 may be formed to protrude from the center of the upper surface of the holder plate 82. The fixing protrusion 83 may be formed above the separation magnet 85. The fixing protrusion 83 may be formed in a cylindrical shape.

The fixing protrusion 83 is formed to be held by the holder locker 52. In detail, the fixing protrusion 83 may be formed so that the fixing protrusion 83 is locked by the locking part of the holder locker 52. For example, a hooking groove 831 may be provided at the upper portion of the fixing protrusion 83. The hooking groove 831 may be formed along the entire circumference of the outer circumferential surface of the fixing protrusion 83. The hooking groove 831 is formed so that the balls 531 of the plurality of ball springs 53 of the holder locker 52 are inserted thereinto.

The pad holder 81 may be coupled to the holder locker 52 of the rotating plate 50 by the hooking groove 831 of the fixing protrusion 83. In detail, when the balls 531 of the plurality of ball springs 53 of the holder locker 52 are inserted into the hooking groove 831 of the fixing protrusion 83 of the pad holder 81, the mop pad assembly 80A may be coupled to or caught in the holder locker 52.

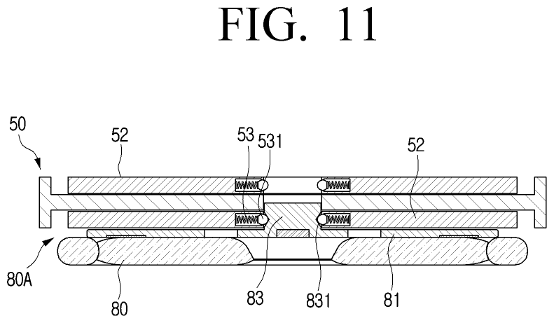

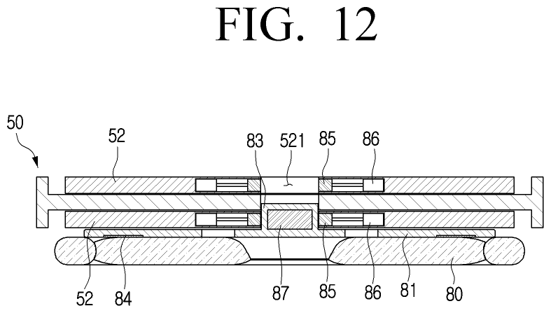

FIG. 11 is a cross-sectional view illustrating a rotating plate 50 of a robot cleaner station 1 according to one or more embodiments of the disclosure to which a mop pad 80 is coupled.

Referring to FIG. 11, the fixing protrusion 83 of the pad holder 81 is inserted into the locking hole 521 of the holder locker 52 of the rotating plate 50. When the fixing protrusion 83 of the pad holder 81 is inserted into the locking hole 521, the plurality of ball springs 53 are compressed by the fixing protrusion 83, so that the fixing protrusion 83 may be inserted into the locking hole 521. When the fixing protrusion 83 of the pad holder 81 is inserted into the locking hole 521 so that the hooking groove 831 of the fixing protrusion 83 is located in front of the plurality of ball springs 53, the plurality of balls 531 are inserted into the hooking groove 831 of the fixing protrusion 83. Accordingly, the mop pad assembly 80A is secured to the holder locker 52.

The lifting device 60 may be configured to move the lifting frame 40 up and down. That is, the lifting frame 40 may move in a vertical direction with respect to the upper surface of the base 10 by the lifting device 60. The lifting device 60 is configured to position the lifting frame 40 in one of two positions, that is, the upper position and the lower position.

Referring to FIGS. 2, 3, and 4, the lifting device 60 may include a pair of rack gears 61.

The pair of rack gears 61 may be disposed on both side surfaces of the lifting frame 40. The pair of rack gears 61 may be disposed perpendicular to the lifting frame 40. The pair of rack gears 61 may be formed integrally with the lifting frame 40. Therefore, when the pair of rack gears 61 moves, the lifting frame 40 may move.

The lifting frame 40 may include a pair of cover frames 42 disposed on both side surfaces of the lifting frame 40. The pair of cover frames 42 may form spaces between both side surfaces of the lifting frame 40 and the pair of rack gears 61, respectively. The rotating shafts 51 and the rotating protrusions 71 may protrude into the internal spaces of the cover frames 42, respectively.

The pair of cover frames 42 may include a left cover frame and a right cover frame. The left cover frame 42 is disposed on the left side surface of the lifting frame 40, and the right cover frame 42 is disposed on the right side surface of the lifting frame 40. The left rack gear 61 is disposed on the side surface of the left cover frame 42, and the right rack gear 61 is disposed on the side surface of the right cover frame 42.

The vertical movement of the lifting frame 40 may be guided by a pair of guiders. The pair of guiders may be disposed on the left and right sides of the lifting frame 40. That is, the pair of guiders may be disposed on the pair of cover frames 42 provided on both side surfaces of the lifting frame 40.

The pair of guiders may be formed as a rail structure. For example, the guider may include a guide rail 62 formed on the side surface of the rack gear 61 and a rail groove 63 formed on the side surface of the case 2 facing the guide rail 62 of the rack gear 61.

In detail, the rail grooves 63 are formed on the left and right inner surfaces of the case 2, respectively. Therefore, when the guide rails 62 of the pair of rack gears 61 disposed on the lifting frame 40, that is, the guide rail 62 of the left rack gear 61 and the guide rail 62 of the right rack gear 61 are respectively inserted into the left rail groove 63 and the right rail groove 63 of the case 2, the pair of rack gears 61 may move up and down along the inner side surfaces of the case 2.

In other words, when the guide rails 62 of the pair of rack gears 61 disposed on both side surfaces of the lifting frame 40 are inserted into the pair of rail grooves 63 formed on both inner side surfaces of the case 2, the pair of rack gears 61 may move up and down along the pair of rail grooves 63 of the case 2. Because the pair of rack gears 61 are disposed on both side surfaces of the lifting frame 40, when the pair of rack gears 61 moves up and down, the lifting frame 40 moves up and down integrally with the pair of rack gears 61.

The lifting device 60 may include a pair of pinions 66 engaged with the pair of rack gears 61. Each of the pair of pinions 66 may be disposed on one side of each pair of rack gears 61. Each of the pair of pinions 66 is disposed to rotate around a fixed shaft formed on the inner side surface of the case 2.

When the pair of pinions 66 rotate, the pair of rack gears 61 may move up and down. In detail, when the pair of pinions 66 rotate in one direction, the pair of rack gears 61 may move upward. When the pair of pinions 66 rotate in opposite direction, the pair of rack gears 61 may move downward.

The lifting device 60 may include a driving gear 64 that drives the pair of pinions 66. The driving gear 64 may include a first driving gear 641, a second driving gear 642, and a connection shaft 643. The first driving gear 641 and the second driving gear 642 are disposed to mesh with the pair of pinions 66. The connection shaft 643 is disposed to connect the first driving gear 641 and the second driving gear 642. Accordingly, the first driving gear 641 and the second driving gear 642 connected by the connection shaft 643 may rotate integrally.

The lifting device 60 may include a motor 65 that rotates the driving gear 64. The motor 65 may be disposed on one side of the first driving gear 641. The motor 65 may include a driving pinion 651 disposed on a motor shaft 65a. The driving pinion 651 may be disposed to mesh with the first driving gear 641.

When the motor 65 operates, the driving pinion 651 disposed on the motor shaft 65a rotates. When the driving pinion 651 rotates, the first driving gear 641 rotates. When the first driving gear 641 rotates, the second driving gear 642 rotates by the connection shaft 643. When the first driving gear 641 and the second driving gear 642 rotate, the pair of pinions 66 rotate. When the pair of pinions 66 rotate, the pair of rack gears 61 may move straight up and down along the inner surface of the case 2. When the pair of rack gears 61 move up and down, the lifting frame 40 may move up and down.

The rotating device 70 is configured to rotate the rotating plate 50 disposed on the lifting frame 40. The rotating device 70 may be distinct from the lifting frame 40 and the rotatable plate 50. Alternatively, the rotating device 70 may be integrated into, or a component of the lifting frame 40 and the rotatable plate 50.

Referring to FIG. 4, the rotating device 70 may include a pair of rotating protrusions 71. The pair of rotating protrusions 71 may be disposed to protrude from both side surfaces of the rotating plate 50. The pair of rotating protrusions 71 may be disposed adjacent to the rotating shafts 51, respectively.

The rotating device 70 may include two pairs of stop grooves 72. The two pairs of stop grooves 72 may be formed to limit the rotation of the rotating plate 50. The two pairs of stop grooves 72 may be formed on both side surfaces of the lifting frame 40. That is, one pair of stop grooves 72 may be formed on the left side surface of the lifting frame 40, and the other pair of stop grooves 72 may be formed on the right side surface of the lifting frame 40. The pair of stop grooves 72 may be formed to be symmetrical about the shaft hole 41.

The stop groove 72 may be formed upward from the lower end of the left side surface and the lower end of the right side surface of the lifting frame 40. That is, the entrance of the stop groove 72 is formed at the lower end of the left side surface and the lower end of the right side surface of the lifting frame 40.

The stop groove 72 may be formed to accommodate the rotating protrusion 71 of the rotating plate 50. The pair of stop grooves 72 formed on the right side surface of the lifting frame 40 may be formed so that the rotating protrusion 71 on the right side surface of the rotating plate 50 is inserted thereinto. The pair of stop grooves 72 formed on the left side surface of the lifting frame 40 may be formed so that the rotating protrusion 71 on the left side surface of the rotating plate 50 is inserted thereinto.

When the pair of rotating protrusions 71 of the rotating plate 50 are respectively inserted into one of the pair of stop grooves 72 formed on each of both side surfaces of the lifting frame 40 and located at the top of the stop groove 72, the rotating plate 50 may no longer rotate above the top of the stop groove 72, that is, in the upward direction of the stop groove 72. However, the rotating plate 50 may rotate below the stop grooves 72, that is, in the downward direction of the stop grooves 72.

The rotating device 70 may include a horizontal device that keeps the rotating plate 50 in a horizontal state, that is, the rotating plate 50 to be parallel to the lifting frame 40. The horizontal device may include a pair of horizontal magnets 73 disposed on the rotating plate 50, and two pairs of horizontal grooves 74 and two pairs of horizontal metals 741 disposed on the lifting frame 40.

The pair of horizontal magnets 73 may be disposed on one side of the rotating protrusions 71 on both side surfaces of the rotating plate 50, respectively. The pair of horizontal magnets 73 may be disposed to protrude from both side surfaces of the rotating plate 50, respectively. The horizontal magnet 73 may be disposed on the opposite side of the rotating shaft 51 based on the rotating protrusion 71. The horizontal magnets 73 may be formed of a permanent magnet.

The two horizontal grooves 74 may be formed outside the two pairs of stop grooves 72 on both side surfaces of the lifting frame 40, respectively. That is, the pair of horizontal grooves 74 are formed outside the pair of stop grooves 72 on the left side surface of the lifting frame 40, and the other pair of horizontal grooves 74 are formed outside the pair of stop grooves 72 on the right side surface of the lifting frame 40.

The horizontal groove 74 may be formed upward from the lower end of the left side surface and the lower end of the right side surface of the lifting frame 40, respectively. That is, the entrances of the horizontal grooves 74 are formed at the lower end of the left side surface and the lower end of the right side surface of the lifting frame 40, respectively.

The horizontal groove 74 may be formed to accommodate the horizontal magnet 73 of the rotating plate 50. The pair of horizontal grooves 74 formed on the right side surface of the lifting frame 40 may be formed so that the horizontal magnet 73 on the right side surface of the rotating plate 50 is inserted thereinto. The pair of horizontal grooves 74 formed on the left side surface of the lifting frame 40 may be formed so that the horizontal magnet 73 on the left side surface of the rotating plate 50 is inserted thereinto.

The two pairs of horizontal metals 741 may be disposed on the upper surface of the lifting frame 40 above the two pairs of horizontal grooves 74. Therefore, when the pair of horizontal magnets 73 of the rotating plate 50 are inserted into one of the two pairs of horizontal grooves 74 of the lifting frame 40, the magnetic force is applied between the horizontal magnet 73 and the horizontal metal 741 to keep the rotating plate 50 in a horizontal state.

The rotating device 70 may include a pair of interference levers 75. The pair of interference levers 75 may be disposed on both sides of the lifting frame 40. When the lifting frame 40 rises, one of the pair of interference levers 75 may interfere with one of the pair of rotating protrusions 71 of the rotating plate 50, thereby rotating the rotating plate 50 at a certain angle with respect to the lifting frame 40.

The pair of interference levers 75 may be substantially identical. Therefore, hereinafter, only one interference lever 75 will be described.

Referring to FIG. 6, the interference lever 75 may include a support plate 76, a lever 77, and a return spring 78.

The support plate 76 is formed in a substantially rectangular flat plate shape, and is disposed perpendicular to the base 10. The lever 77 and the return spring 78 may be disposed on the top of the support plate 76.

The lever 77 is formed in a bar shape and is hingedly disposed at the top of the support plate 76. A pair of hinge shafts 771 are provided on both side surfaces of the lever 77. The pair of hinge shafts 771 are disposed closer to the rear end of the lever 77 than the front end thereof.

A pair of hinge protrusions 761 including a hinge hole are formed on one end of the top of the support plate 76. When the pair of hinge shafts 771 of the lever 77 are inserted into the pair of hinge holes of the support plate 76, the lever 77 may rotate at a certain angle with respect to the support plate 76. Accordingly, the lever 77 may pivot at a certain angle with respect to the upper end of the support plate 76.

The return spring 78 is disposed to maintain the lever 77 in a horizontal state. The return spring 78 may be disposed between the lever 77 and a protrusion 762. The protrusion 762 is formed to protrude upward from the other end of the top of the support plate 76. One end of the return spring 78 is fixed to the rear end of the lever 77, and the other end of the return spring 78 is fixed to the protrusion 762 of the support plate 76. Accordingly, the lever 77 may be maintained in a horizontal state by the return spring 78.

As illustrated in FIGS. 3 and 4, the pair of interference levers 75 may be disposed diagonally on both sides of the lifting frame 40. That is, the pair of interference levers 75 may include a right interference lever 75 disposed on the right side of the rotating shaft 51 of the rotating plate 50 and a left interference lever 75 disposed on the left side of the rotating shaft 51. The left interference lever 75 may be disposed in the space between the left side surface of the lifting frame 40 and the left cover frame 42, and the right interference lever 75 may be disposed in the space between the right side surface of the lifting frame 40 and the right cover frame 42.

In the case that the rotating protrusion 71 of the rotating plate 50 is located on the right side of the rotating shaft 51, when the lifting frame 40 rises, the rotating protrusion 71 interferes with the right interference lever 75 so that the rotating plate 50 is rotated in the clockwise direction. Because the rotating protrusions 71 of the rotating plate 50 are located in the stop grooves 72 of the lifting frame 40, the rotating protrusions 71 may not move upward. Therefore, in the case that the lifting frame 40 is lowered, when the rotating protrusion 71 of the rotating plate 50 interferes with the right interference lever 75, the lever 77 rotates downward and the rotating plate 50 does not rotate. When the rotating protrusion 71 of the rotating plate 50 passes the lever 77, the lever 77 may be returned to the horizontal state by the return spring 78.

In the case that the rotating protrusion 71 of the rotating plate 50 is located on the left side of the rotating shaft 51, when the lifting frame 40 rises, the rotating protrusion 71 interferes with the left interference lever 75 so that the rotating plate 50 is rotated in the counter-clockwise direction. In the case that the lifting frame 40 is lowered, when the rotating protrusion 71 of the rotating plate 50 interferes with the left interference lever 75, the lever 77 rotates downward and the rotating plate 50 does not rotate. When the rotating protrusion 71 of the rotating plate 50 passes the lever 77, the lever 77 may be returned to the horizontal state by the return spring 78.

The rotating device 70 may include a plurality of pushers 79. The plurality of pushers 79 may be disposed above both side ends of the rotating plate 50 to push the rotating plate 50 downward. The plurality of pushers 79 may be disposed on the left and right inner surfaces of the case 2 above the lifting frame 40. The plurality of pushers 79 may be disposed to contact or be adjacent to the rotating plate 50 when the lifting frame 40 is located in the upper position.

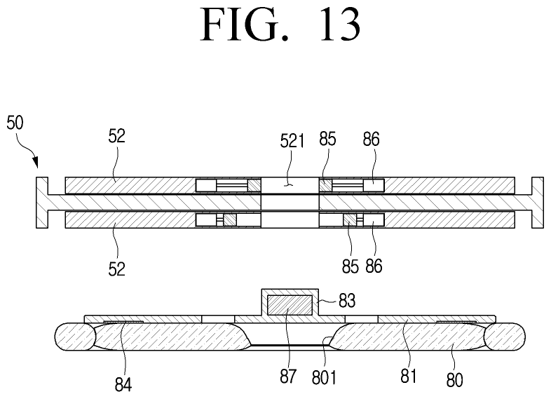

In the above, the holder locker 52 that secures the pad holder 81 using the plurality of ball springs 53 is shown and described. However, the structure of the holder locker 52 is not limited thereto. The holder locker 52 may be configured in various ways as long as it can selectively release and secure the pad holder 81. For example, as illustrated in FIGS. 12 and 13, the holder locker 52 may be configured to secure the pad holder 81 using a permanent magnet.

FIG. 12 is a cross-sectional view illustrating a pad holder 81 coupled to a holder locker 52 of a robot cleaner station 1 according to one or more embodiments of the disclosure. FIG. 13 is a cross-sectional view illustrating the pad holder 81 separated from the holder locker 52 of FIG. 12.

Referring to FIG. 12, the holder locker 52 may be formed in a disk shape. A locking hole 521 may be formed in the center of the holder locker 52. The locking hole 521 may be formed so that the fixing protrusion 83 of the pad holder 81 is inserted thereinto.

A plurality of metal blocks 861 may be disposed around the locking hole 521. Each of the plurality of metal blocks 861 may be disposed to reciprocate a certain distance in the radial direction of the holder locker 52. The plurality of metal blocks 861 may be arranged at regular intervals in the circumferential direction of the locking hole 521. Each of the plurality of metal blocks 861 may reciprocate a certain distance by an actuator 86. For example, the metal block 861 may be configured to move using a solenoid.

The pad holder 81 may include a holder plate 82 and a fixing protrusion 83.

The holder plate 82 may be formed so that a mop pad 80 is attached to the lower surface of the holder plate 82. The holder plate 82 may be formed in a shape corresponding to the mop pad 80. For example, the holder plate 82 may be formed in a disk shape. The holder plate 82 may be formed to have a diameter smaller than or similar to that of the mop pad 80.

A plurality of Velcro 84 may be disposed on the lower surface of the holder plate 82 at regular intervals. The mop pad 80 may be fixed or attached to the lower surface of the holder plate 82 by the plurality of Velcro 84. When the mop pad 80 is attached to the lower surface of the holder plate 82, a mop pad assembly 80A is formed.

The fixing protrusion 83 may be formed to protrude from the center of the upper surface of the holder plate 82. The fixing protrusion 83 is formed to be inserted into the locking hole 521 of the holder locker 52. The fixing protrusion 83 may be formed in a cylindrical shape. A permanent magnet 87 may be disposed inside the fixing protrusion 83.

The pad holder 81 may be fixed to the holder locker 52 by magnetic force between the permanent magnet 87 of the fixing protrusion 83 and the plurality of metal blocks 861 of the holder locker 52.

In other words, as illustrated in FIG. 12, in a state in which the fixing protrusion 83 of the pad holder 81 is inserted into the locking hole 521 of the holder locker 52, when the metal blocks 861 are adjacent to the locking hole 521, the pad holder 81 may be fixed to the holder locker 52 by magnetic force between the permanent magnet 87 of the fixing protrusion 83 and the plurality of metal blocks 861 of the holder locker 52.

As illustrated in FIG. 13, when the plurality of metal blocks 861 of the holder locker 52 move away from the locking hole 521, no magnetic force is applied between the permanent magnet 87 of the fixing protrusion 83 and the plurality of metal blocks 861, so that the pad holder 81 may be separated from the holder locker 52.

Hereinafter, with reference to FIGS. 14 and 15, a robot cleaner system 200 according to one or more embodiments of the disclosure will be described in detail.

FIG. 14 is a view illustrating a robot cleaner system 200 according to one or more embodiments of the disclosure. FIG. 15 is a block diagram of a robot cleaner system 200 according to one or more embodiments of the disclosure.

Referring to FIGS. 14 and 15, the robot cleaner system 200 according to one or more embodiments of the disclosure may include a robot cleaner station 1 and a robot cleaner 100.

In the following description, for convenience of description, a mop pad assembly 80A including a mop pad 80 and a pad holder 81 is referred to as the mop pad 80. That is, the used mop pad 80′ refers to the used mop pad assembly 80A, and the cleaned mop pad 80 refers to the cleaned mop pad assembly 80A.

The robot cleaner station 1 is configured to receive the used mop pad 80′ from the robot cleaner 100 and supply the cleaned mop pad 80 to the robot cleaner 100. The robot cleaner station 1 is configured to clean the used mop pad 80′ and supply the cleaned mop pad 80 to the robot cleaner 100.

The robot cleaner station 1 may include a base 10, a pad cleaner 20, and a pad moving device 30. Because the base 10, the pad cleaner 20, and the pad moving device 30 have been described above, redundant descriptions thereof are omitted.

The robot cleaner station 1 may include a position sensor 91, a communication part 93, and a processor 90.

The position sensor 91 may be configured to detect the position of the lifting frame 40, that is, the vertical position of the lifting frame 40. For example, the position sensor 91 may be configured to recognize which of two positions the lifting frame 40 is located in, that is, an upper position and a lower position.

The position sensor 91 may be implemented with a plurality of physical sensors. Alternatively, the position sensor 91 may be implemented in software using the rotation angle of a motor 65.

The communication part 93 is configured to communicate wirelessly with the robot cleaner 100. For example, the communication part 93 may transmit a signal indicating that the mop pad 80 is ready to the robot cleaner 100. In addition, the communication part 93 may receive from the robot cleaner 100 a signal indicating that mounting of the mop pad 80 has been completed and a signal indicating that detachment of the mop pad 80 has been completed.

The communication part 93 may be configured to communicate with a mobile device such as a smartphone, a tablet computer, and the like. The communication part 93 may be connected to the mobile device through various mobile communication methods such as Bluetooth, WiFi, 4G, 5G, etc.

The processor 90 may be configured to control the robot cleaner station 1. The processor 90 may control the motor 65 of the pad moving device 30 to position the lifting frame 40 in one of two positions, that is, the upper position and the lower position. The processor 90 may control the pad cleaner 20 to clean the mop pad 80 fixed to the lifting frame 40.

The processor 90 may recognize the position of the lifting frame 40 based on a signal transmitted from the position sensor 91. That is, the processor 90 may use the signal transmitted from the position sensor 91 to recognize whether the lifting frame 40 is located in the upper position or the lower position.

The processor 90 may control the pad moving device 30 and the pad cleaner 20 to clean the used mop pad 80′ fixed to the lifting frame 40.

In detail, the processor 90 controls the pad moving device 30 to position the lifting frame 40 to which the used mop pad 80′ is fixed in the lower position, and controls the pad cleaner 20 to clean the used mop pad 80′ fixed to the lifting frame 40.

The robot cleaner 100 is configured to autonomously travel on the surface to be cleaned. The robot cleaner 100 is configured to receive the cleaned mop pad 80 from the robot cleaner station 1.

The robot cleaner 100 may mop the surface to be cleaned using the mop pad 80 supplied from the robot cleaner station 1.

When mopping is completed, the robot cleaner 100 is configured to return the used mop pad 80′ to the robot cleaner station 1 and receive the cleaned mop pad 80 from the robot cleaner station 1. That is, the robot cleaner 100 is configured to replace the used mop pad 80′ with the cleaned mop pad 80 using the robot cleaner station 1.

The robot cleaner 100 may include a moving device 101, a position recognition sensor 102, a suction device 103, a mopping device 104, a mop pad attaching and detaching device 105, a robot communication part 106, and a robot processor 109.

The moving device 101 may be configured to move the robot cleaner 100 on the surface to be cleaned. For example, the moving device 101 may include a pair of wheels. The pair of wheels may be rotatably disposed on the left and right side surfaces of the robot cleaner 100.

The position recognition sensor 102 may be configured so that the robot cleaner 100 recognizes its own position. The robot cleaner 100 may recognize its own location using the position recognition sensor 102. For example, a sensor capable of recognizing the current location of the robot cleaner 100, such as an image sensor, a LiDAR sensor, etc. may be used as the position recognition sensor 102.

The suction device 103 may be configured to generate suction force to collect dirt on the surface to be cleaned. For example, the suction device 103 may include a suction motor and a dust collection device. The suction motor may be configured to generate suction force. The dust collection device may be connected to a suction nozzle provided at the bottom of the robot cleaner 100 to face the surface to be cleaned. Accordingly, when the suction motor operates, dirt on the surface to be cleaned may be sucked into the dust collection device through the suction nozzle. The dust collection device may be configured to separate and collect dirt that is sucked in along with air through the suction nozzle by the suction force of the suction motor.

The mopping device 104 is configured to mop the surface to be cleaned by rotating the mop pad 80. The mopping device 104 may be provided on the lower surface of the robot cleaner 100. The mopping device 104 may be configured to rotate the mop pad 80 while the mop pad 80 is in contact with the surface to be cleaned. In this embodiment, the mopping device 104 is configured to rotate two mop pads 80.

The mopping device 104 may be configured to move the mop pad 80 a certain distance in the vertical direction. That is, the mopping device 104 may be configured to position the mop pad 80 in one of the raised position and the lowered position.

The mop pad attaching and detaching device 105 may be configured to mount the mop pad 80 on the mopping device 104 provided on the lower surface of the robot cleaner 100. In addition, the mop pad attaching and detaching device 105 may be configured to separate the mop pad 80 mounted on the mopping device 104. In the case of this embodiment, the mop pad attaching and detaching device 105 is configured to attach and detach two mop pads 80.

The robot communication part 106 may be configured to communicate wirelessly with the robot cleaner station 1. For example, when the robot cleaner 100 completes mounting of the mop pad 80, the robot communication part 106 may transmit a mop pad mounting signal to the robot cleaner station 1. In addition, when the robot cleaner 100 completes separation of the mop pad 80, the robot communication part 106 may transmit a mop pad separation signal to the robot cleaner station 1.

The robot communication part 106 may be configured to communicate with a mobile device such as a smartphone, a tablet computer, and the like. The robot communication part 106 may be connected to the mobile device through various mobile communication methods such as Bluetooth, WiFi, 4G, 5G, etc.

The robot processor 109 is configured to control the robot cleaner 100. For example, the robot processor 109 may be configured to control the moving device 101, the position recognition sensor 102, the suction device 103, the mopping device 104, the mop pad attaching and detaching device 105, and the robot communication part 106.

A robot processor 109 according to embodiments of the present disclosure may include one or more processors. The one or more processors may include one or more of a central processing unit (CPU), a many integrated core (MIC), a field-programmable gate array (FPGA), a digital signal processor (DSP), a hardware accelerator, etc. The one or more processors are able to perform control of any one or any combination of the other components of the robot cleaner 100, and/or perform an operation or data processing relating to communication. The one or more processors execute one or more programs stored in at least one memory.

The robot processor 109 may control the moving device 101 to move the robot cleaner 100. The robot processor 109 may recognize the current location of the robot cleaner 100 using the position recognition sensor 102. The robot processor 109 may move the robot cleaner 100 to an arbitrary location using the position recognition sensor 102 and the moving device 101.

The robot processor 109 may control the suction device 103 to suck in dirt from the surface to be cleaned. The robot processor 109 may control the moving device 101 and the suction device 103 to move the robot cleaner 100 and suck in dirt from the surface to be cleaned.

The robot processor 109 may control the mopping device 104 to rotate the mop pad 80, thereby mopping the surface to be cleaned. The robot processor 109 may control the moving device 101 and the mopping device 104 to move the robot cleaner 100 and rotate the mop pad 80, thereby mopping the surface to be cleaned.

The robot processor 109 may control the mopping device 104 to position the mop pad 80 in one of the raised position and the lowered position.

The robot processor 109 may control the mop pad attaching and detaching device 105 to mount the mop pad 80 to the mopping device 104. In addition, the robot processor 109 may control the mop pad attaching and detaching device 105 to separate the mop pad 80 mounted on the mopping device 104.

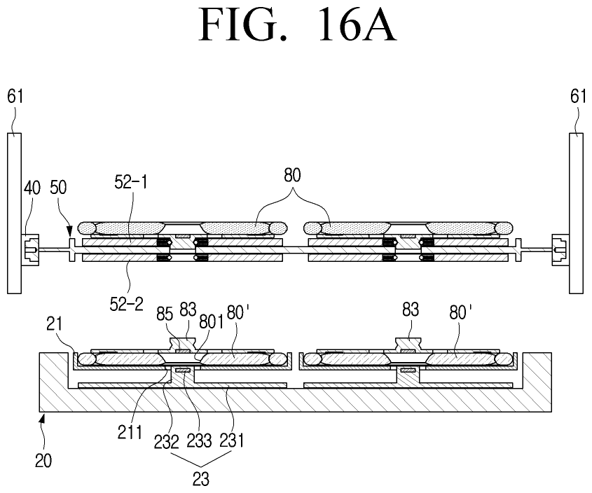

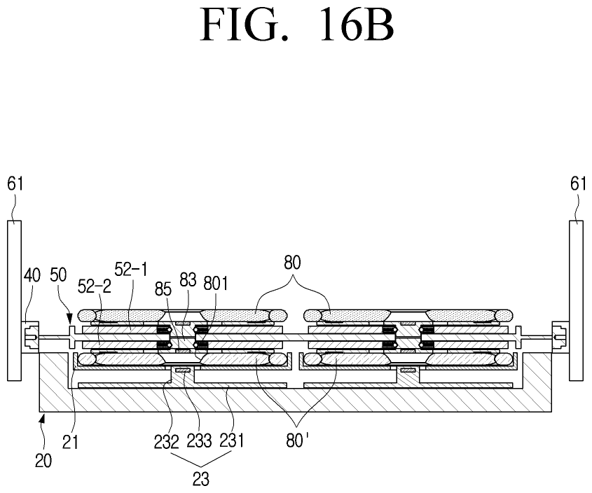

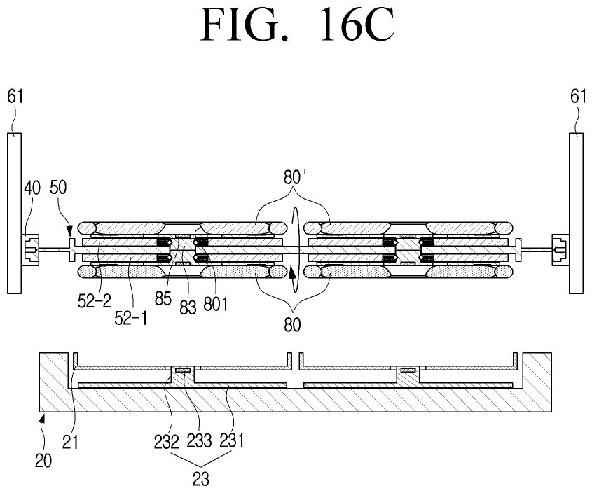

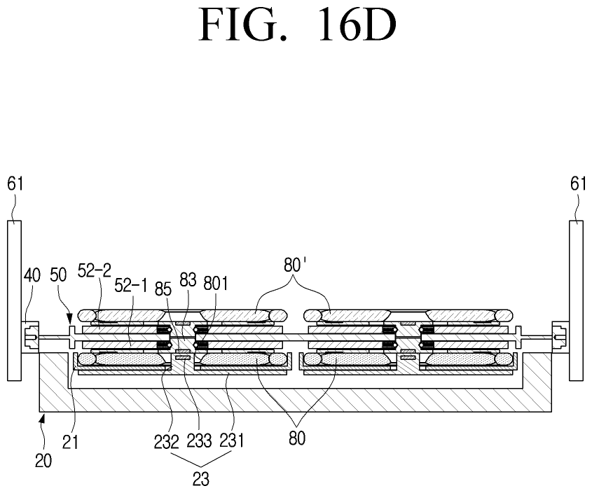

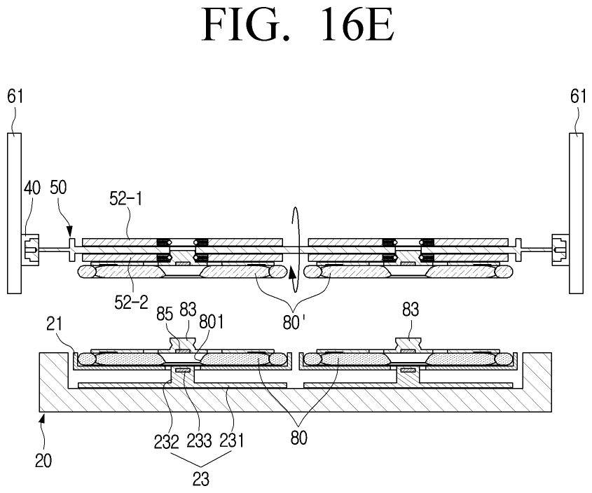

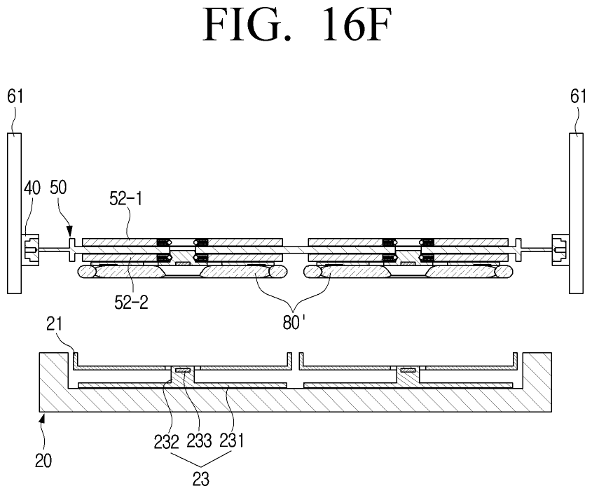

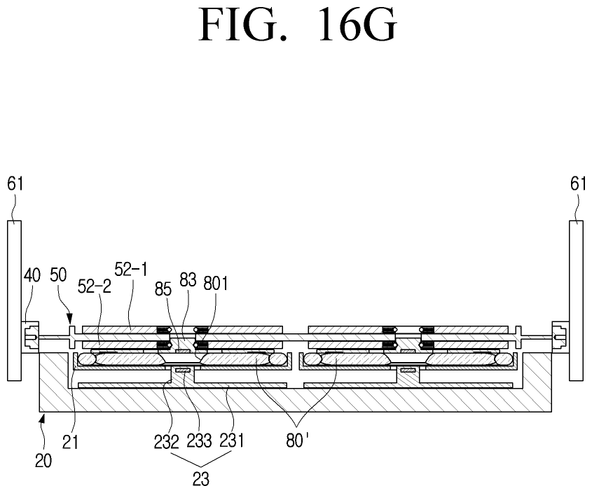

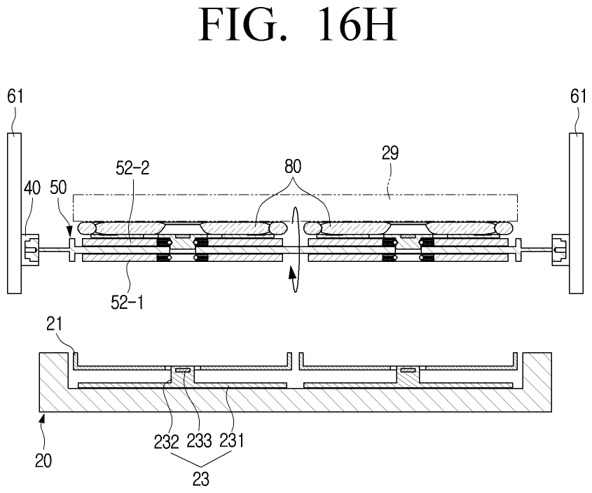

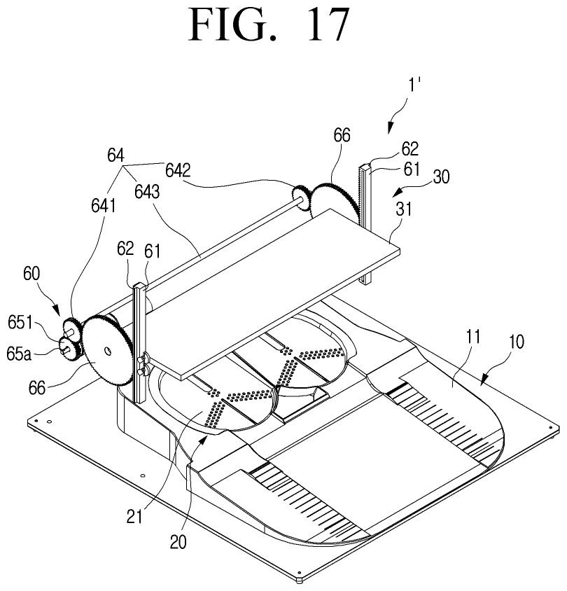

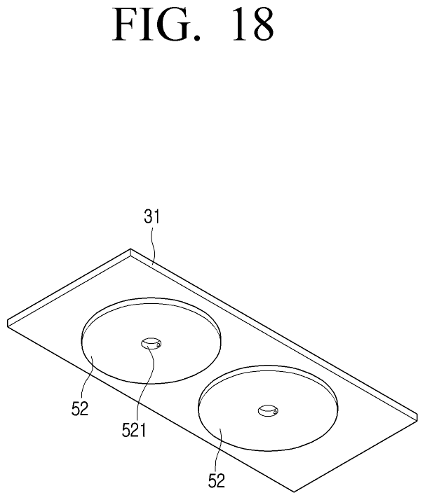

Hereinafter, a method of replacing the mop pad of the robot cleaner system 200 including the robot cleaner station 1 and the robot cleaner 100 will be described in detail with reference to FIGS. 16A, 16B, 16C, 16D, 16E, 16F, 16G, and 16H.

FIGS. 16A, 16B, 16C, 16D, 16E, 16F, 16G, and 16H are views for explaining a method of replacing a mop pad 80 using a robot cleaner system 200 according to one or more embodiments of the disclosure.

In the following description, for convenience of description, a mop pad assembly 80A including a mop pad 80 and a pad holder 81 is referred to as the mop pad 80. That is, the used mop pad 80′ refers to the used mop pad assembly 80A′, and the cleaned mop pad 80 refers to the cleaned mop pad assembly 80A.

After mopping, the robot cleaner 100 enters the robot cleaner station 1 and is located on the upper surface of the base 10. At this time, the used mop pad 80′ mounted on the mopping device 104 of the robot cleaner 100 is positioned above the pad cleaner 20 of the base 10. The robot processor 109 controls the mop pad attaching and detaching device 105 to separate the used mop pad 80′ mounted on the mopping device 104. Then, as illustrated in FIG. 16A, the separated used mop pad 80′ is located in the pad seat 21 of the pad cleaner 20.

FIG. 16A is a view illustrating a state in which the mop pads 80′ used by the robot cleaner 100 are placed on the pad seat 21 of the pad cleaner 20 of the robot cleaner station 1.

Referring to FIG. 16A, the used mop pad 80′ is located on the pad seat 21. A pad fixing device 23 is disposed below the pad seat 21. Accordingly, the pad fixing device 23 is located below the used mop pad 80′. In detail, an insertion protrusion 232 of the pad fixing device 23 is located in the original position. Accordingly, the used mop pad 80′ is not fixed to the pad seat 21 by the pad fixing device 23.

The pad fixing device 23 is configured to fix the mop pad 80 and 80′ to the pad seat 21. The pad seat 21 includes a through hole 211 formed in the center of the pad seat 21. The pad fixing device 23 may include a moving plate 231 and the insertion protrusion 232 protruding from the center of the moving plate 231. The insertion protrusion 232 is formed to be inserted into the through hole 211 of the pad seat 21. A metal piece 233 may be disposed inside an upper portion of the insertion protrusion 232.

The moving plate 231 is formed to move in the vertical direction. The insertion protrusion 232 may be positioned at one of the original position and the insertion position by the moving plate 231.

When the insertion protrusion 232 is located in the original position, the top of the insertion protrusion 232 is located below the mop pad 80′, that is, at the same level as or below the upper surface of the pad seat 21. When the insertion protrusion 232 is located in the original position, the mop pad 80′ is not fixed to the pad seat 21.

When the insertion protrusion 232 is located at the insertion position, the insertion protrusion 232 protrudes from the through hole 211 of the pad seat 21 and is inserted into the mop hole 801 of the mop pad 80′, so that the upper end of the insertion protrusion 232 is adjacent to or contacts the separation magnet 85 of the pad holder 81. When the insertion protrusion 232 is located at the insertion position, the mop pad 80′ is fixed to the pad seat 21.

In addition, the cleaned mop pad 80 is fixed to the first holder locker 52-1 on the upper surface, that is, the first surface, of the rotating plate 50, and no mop pad 80 is fixed to the second holder locker 52-2 on the lower surface, that is, the second surface, of the rotating plate 50.

In this state, the processor 90 controls the lifting device 60 to lower the lifting frame 40 and fix the used mop pad 80′ to the lower surface, that is, the second surface, of the rotating plate 50. This state is shown in FIG. 16B.

FIG. 16B is a view illustrating a state in which the lifting frame 40 is lowered so that the used mop pad 80′ placed on the pad seat 21 of the pad cleaner 20 is fixed to the second surface of the rotating plate 50.

Referring to FIG. 16B, the second holder locker 52-2 disposed on the lower surface, that is, the second surface, of the rotating plate 50 of the lifting frame 40 fixes the used mop pad 80′. In detail, when the lifting frame 40 is lowered, the fixing protrusion 83 of the used mop pad 80′ is inserted into the locking hole 521 of the second holder locker 52-2 disposed on the second surface of the rotating plate 50. Then, because the balls 531 of the plurality of ball springs 53 provided in the locking hole 521 are inserted into the hooking groove 831 of the fixing protrusion 83, the used mop pad 80′ is fixed to the second holder locker 52-2.

At this time, the insertion protrusion 232 of the pad fixing device 23 maintains its original position.

In this state, the processor 90 controls the lifting device 60 to raise the lifting frame 40. When the lifting frame 40 rises, the rotating protrusion 71 of the rotating plate 50 interferes with the interference lever 75, so that the rotating plate 50 is rotated more than 120 degrees. When the lifting frame 40 continues to rise and is positioned at the upper position, the rotating plate 50 is rotated by about 180 degrees by the plurality of pushers 79. This state is shown in FIG. 16C.

FIG. 16C is a view illustrating a state in which the lifting frame 40 is raised, the used mop pad 80′ is located above the lifting frame 40, and the cleaned mop pad 80 is located below the lifting frame 40.

Referring to FIG. 16C, the used mop pad 80′ fixed to the second holder locker 52-2 on the second surface of the rotating plate 50 is located on the upper side of the lifting frame 40, and the cleaned mop pad 80 fixed to the first holder locker 52-1 on the first surface of the rotating plate 50 is located on the lower side of the lifting frame 40. That is, the cleaned mop pad 80 faces the pad cleaner 20.

In this state, the processor 90 controls the lifting device 60 to lower the lifting frame 40. When the lifting frame 40 is lowered, the rotating protrusion 71 of the rotating plate 50 comes into contact with the interference lever 75. However, because the rotating protrusion 71 is inserted into the stop groove 72 of the lifting frame 40, the rotating plate 50 does not rotate, and the lever 77 of the interference lever 75 is bent downward.

When the lifting frame 40 is positioned in the lower position, the cleaned mop pad 80 is positioned in the pad seat 21 of the pad cleaner 20. In this state, the processor 90 controls the pad fixing device 23 of the pad cleaner 20 to move the insertion protrusion 232 to the insertion position. Then, the insertion protrusion 232 is inserted into the mop hole 801 of the cleaned mop pad 80 and magnetically coupled to the pad holder 81. This state is shown in FIG. 16D.

FIG. 16D is a view illustrating a state in which the lifting frame 40 is lowered and the cleaned mop pad 80 is located in the pad seat 21 of the pad cleaner 20.

Referring to FIG. 16D, the lifting frame 40 is located in the lower position, and the cleaned mop pad 80 fixed to the first holder locker 52-1 of the rotating plate 50 is located in the pad seat 21. The pad holder 81 of the cleaned mop pad 80 is magnetically coupled to the insertion protrusion 232 of the pad cleaner 20.

In this state, the processor 90 controls the lifting device 60 to raise the lifting frame 40. At this time, the pad holder 81 of the cleaned mop pad 80 is magnetically coupled to the insertion protrusion 232 of the pad cleaner 20, so when the lifting frame 40 rises, the cleaned mop pad 80 is separated from the first holder locker 52-1 of the rotating plate 50 and remains on the pad seat 21.

When the lifting frame 40 rises, the rotating protrusion 71 of the rotating plate 50 interferes with the interference lever 75, so that the rotating plate 50 is rotated more than 120 degrees. When the lifting frame 40 continues to rise and is positioned at the upper position, the rotating plate 50 is rotated by about 180 degrees by the plurality of pushers 79.

When the lifting frame 40 rises, the processor 90 controls the pad fixing device 23 to move the insertion protrusion 232 to its original position. Then, the coupling between the pad holder 81 of the cleaned mop pad 80 and the insertion protrusion 232 of the pad cleaner 20 is released. This state is shown in FIG. 16E.

FIG. 16E is a view illustrating a state in which the lifting frame 40 is raised so that the used mop pad 80′ is located below the lifting frame 40, and the cleaned mop pad 80 is placed on the pad seat 21 of the pad cleaner 20.

Referring to FIG. 16E, the lifting frame 40 is located at the upper position, and the used mop pad 80′ fixed to the second holder locker 52-2 of the rotating plate 50 is located on the lower side of the lifting frame 40 so as to face the pad cleaner 20. The pad holder 81 of the cleaned mop pad 80 placed in the pad seat 21 is not coupled to the insertion protrusion 232 of the pad fixing device 23.

In this state, the processor 90 may control the communication part 93 to transmit a mop pad preparation signal to the robot cleaner 100.

When the robot cleaner 100 receives the mop pad preparation signal from the robot cleaner station 1, the robot cleaner 100 enters the robot cleaner station 1 and mounts the cleaned mop pad 80 located on the pad seat 21 of the base 10 to itself.

In detail, when the robot processor 109 receives the mop pad preparation signal from the robot cleaner station 1 through the robot communication part 106, the robot processor 109 controls the moving device 101 to move the robot cleaner 100 to the base 10 of the robot cleaner station 1.

When the robot cleaner 100 is positioned on the upper surface of the base 10, the mopping device 104 of the robot cleaner 100 is positioned above the pad seat 21 of the pad cleaner 20. Then, the robot processor 109 controls the mop pad attaching and detaching device 105 to attach the mop pad 80 to the mopping device 104.

When attachment of the mop pad 80 is completed, the robot processor 109 controls the moving device 101 to move the robot cleaner 100 to the outside of the robot cleaner station 1 and controls the robot communication part 106 to transmit a mop pad attaching signal to the robot cleaner station 1.

After that, the robot processor 109 controls the robot cleaner 100 to mop the surface to be cleaned.

The state in which the robot cleaner 100 is equipped with the cleaned mop pad 80 and leaves the robot cleaner station 1 is shown in FIG. 16F.

Referring to FIG. 16F, the used mop pad 80′ fixed to the second holder locker 52-2 of the rotating plate 50 faces the pad cleaner 20, and there is no mop pad 80 in the pad cleaner 20.

Upon receiving the mop pad attaching signal from the robot cleaner 100, the processor 90 controls the lifting device 60 to lower the lifting frame 40. Because the rotating plate 50 does not rotate when the lifting frame 40 is lowered, the used mop pad 80′ is located on the lower side of the lifting frame 40.

When the lifting frame 40 is located in the lower position, the used mop pad 80′ is located on the pad seat 21 of the pad cleaner 20. In this state, the processor 90 controls the pad cleaner 20 to clean the used mop pad 80′. This state is shown in FIG. 16G.

FIG. 16G is a view illustrating a state in which the pad cleaner 20 cleans the used mop pad 80′ fixed to the lifting frame 40 located at the lower position.

Referring to FIG. 16G, when the pad cleaner 20 cleans the used mop pad 80′, the pad holder 81 of the used mop pad 80′ is not coupled to the insertion protrusion 232 of the pad fixing device 23. That is, when the pad cleaner 20 cleans the used mop pad 80′, the insertion protrusion 232 of the pad fixing device 23 is positioned in its original position.

When cleaning of the used mop pad 80′ by the pad cleaner 20 is completed, the used mop pad 80′ becomes a cleaned mop pad 80.

When cleaning of the mop pad 80 is completed, the processor 90 controls the lifting device 60 to raise the lifting frame 40. When the lifting frame 40 rises, the rotating protrusion 71 of the rotating plate 50 interferes with the interference lever 75, so that the rotating plate 50 is rotated more than 120 degrees. When the lifting frame 40 continues to rise and is positioned at the upper position, the rotating plate 50 is rotated by about 180 degrees by the plurality of pushers 79. Accordingly, the cleaned mop pad 80 is located on the upper side of the lifting frame 40.

When the lifting frame 40 is located in the upper position, the processor 90 controls the pad drying device 29 to dry the cleaned mop pad 80. This state is shown in FIG. 16H.

FIG. 16H is a view illustrating a state in which the cleaned mop pad 80 fixed to the lifting frame 40 located at the upper position is dried by the pad drying device 29.

Referring to FIG. 16H, the cleaned mop pad 80 fixed to the second holder locker 52-2 of the rotating plate 50 is located on the upper side of the lifting frame 40 and faces the pad drying device 29. Accordingly, when the pad drying device 29 is operated by the processor 90, the cleaned mop pad 80 fixed to the rotating plate 50 is dried. At this time, no mop pad 80 is fixed to the first holder locker 52-1 of the rotating plate 50 located on the lower side of the lifting frame 40.

In the robot cleaner system 200 according to one or more embodiments of the disclosure, the robot cleaner station 1 may clean the used mop pad 80′ while the robot cleaner 100 performs mopping. Therefore, compared to the robot cleaner according to the prior art configured to clean the mop pad while the mop pad is attached to the robot cleaner, the robot cleaner system 200 according to one or more embodiments of the disclosure may clean the used mop pad 80′ over a sufficient period of time, and thus may reliably clean the used mop pad 80′.

In addition, the robot cleaner system 200 according to one or more embodiments of the disclosure separates the used mop pad 80′ from the robot cleaner 100 and cleans the used mop pad 80′, so that the used mop pad 80′ may be dried with hot air at a high-temperature and may be chemically disinfected.

Hereinafter, with reference to FIGS. 17, 18, 19, and 20, a robot cleaner station 1′ according to one or more embodiments of the disclosure will be described in detail

FIG. 17 is a perspective view illustrating a robot cleaner station 1′ according to one or more embodiments of the disclosure. FIG. 18 is a bottom perspective view illustrating a lifting plate 31 of the robot cleaner station 1′ of FIG. 17.

Referring to FIG. 17, a pad moving device 30 according to one or more embodiments of the disclosure may include a lifting plate 31 and a lifting device 60.

The lifting plate 31 may be formed in a rectangular shape. The lifting plate 31 may be formed in a substantially rectangular flat plate. The lifting plate 31 may be formed to move up and down by the lifting device 60.

The lifting plate 31 may include a holder locker 52. The holder locker 52 may be disposed on the lower surface of the lifting plate 31. In the case of this embodiment, as illustrated in FIG. 18, two holder lockers 52 are disposed on the lower surface of the lifting plate 31.

The holder locker 52 is formed to support and secure the mop pad 80. The holder locker 52 may be configured to selectively hold or release the mop pad 80. When the mop pad 80 is fixed to the pad holder 81 as in this embodiment, the holder locker 52 may be configured to selectively hold or release the pad holder 81.

The holder locker 52 is the same as or similar to the holder locker 52 of the robot cleaner station 1 according to the above-described embodiment; therefore, a redundant description thereof is omitted.

The lifting device 60 may be configured to move the lifting plate 31 up and down. That is, the lifting plate 31 may move in a vertical direction with respect to the upper surface of the base 10 by the lifting device 60. The lifting device 60 may be configured to position the lifting plate 31 in one of two positions, that is, the upper position and the lower position.

The lifting device 60 may include a pair of rack gears 61.

The pair of rack gears 61 may be disposed on both side surfaces of the lifting plate 31. The pair of rack gears 61 may be disposed perpendicularly to the lifting plate 31. The pair of rack gears 61 may be formed integrally with the lifting plate 31. Therefore, when the pair of rack gears 61 moves, the lifting plate 31 may move.

The vertical movement of the lifting plate 31 may be guided by a pair of guiders. The pair of guiders may be disposed on the left and right sides of the lifting plate 31.

The pair of guiders may be formed as a rail structure. For example, the guider may include a guide rail 62 formed on the side surface of the rack gear 61 and a rail groove 63 formed on the side surface of the case 2 facing the guide rail 62 of the rack gear 61.

In detail, the rail groove 63 is formed on each of the left and right inner surfaces of the case 2 (see FIG. 3). Therefore, when the guide rails 62 of the pair of rack gears 61 disposed on the lifting plate 31, that is, the guide rail 62 of the left rack gear 61 and the guide rail 62 of the right rack gear 61 are respectively inserted into the left rail groove 63 and the right rail groove 63 of the case 2, the pair of rack gears 61 may move up and down along the inner side surfaces of the case 2.

In other words, when the guide rails 62 of the pair of rack gears 61 disposed both side surfaces of the lifting plate 31 are inserted into the pair of rail grooves 63 formed on both inner side surfaces of the case 2, the pair of rack gears 61 may move up and down along the rail grooves 63 of the case 2. Because the pair of rack gears 61 are disposed on both side surfaces of the lifting plate 31, when the pair of rack gears 61 move up and down, the lifting plate 31 may move up and down integrally with the pair of rack gears 61.

The lifting device 60 may include a pair of pinions 66 engaged with the pair of rack gears 61, a driving gear 64 that drives the pair of pinions 66, and a motor 65 that rotates the driving gear 64.

The pair of pinions 66, the driving gear 64, and the motor 65 are the same as or similar to them of the lifting device 60 of the robot cleaner station 1 according to the above-described embodiment; therefore, redundant descriptions thereof are omitted.

When the motor 65 operates, the pair of rack gears 61 may move straight up and down along the inner surface of the case 2 by the driving gear 64 and the pair of pinions 66. When the pair of rack gears 61 moves up and down, the lifting plate 31 may move up and down.

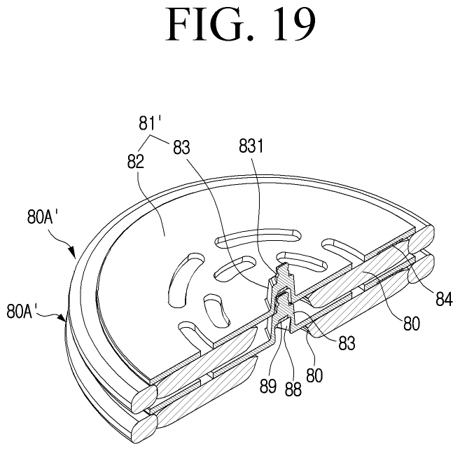

The mop pad assembly 80A′ used in the robot cleaner station 1′ according to one or more embodiments of the disclosure is formed so that two mop pad assemblies 80A′ may be stacked as illustrated in FIG. 19.

FIG. 19 is a cross-sectional perspective view illustrating a stacked state of two mop pad assemblies 80A′ used in a robot cleaner station 1′ according to one or more embodiments of the disclosure.

Referring to FIG. 19, the mop pad assembly 80A′ according to one or more embodiments of the disclosure includes a pad holder 81′ and a mop pad 80.

The mop pad 80 may be fixed to the lower surface of the pad holder 81′. The mop pad 80 may be detachably fixed to the lower surface of the pad holder 81′. For example, the mop pad 80 may be attached to the lower surface of the pad holder 81′ with Velcro 84.

The mop pad 80 may be formed approximately in the shape of a disk. A mop hole 801 may be formed in the center of the mop pad 80. The mop hole 801 may be formed to penetrate the mop pad 80 vertically.

One surface of the mop pad 80 is formed as a mop surface that may be used to mop the surface to be cleaned, and the opposite surface thereof is formed as a detachable surface that may be attached to and detached from the lower surface of the pad holder 81′. The detachable surface may be formed to be attached to Velcro 84. The mop pad 80 may be attached to or detached from the mopping device 104 of the robot cleaner 100 using the detachable surface.

The pad holder 81′ may include a holder plate 82 and a fixing protrusion 83.

The holder plate 82 may be formed so that the mop pad 80 is attached to the lower surface of the holder plate 82. The holder plate 82 may be formed in a shape corresponding to the mop pad 80. For example, the holder plate 82 may be formed in a disk shape. The holder plate 82 may be formed to have a diameter smaller than or similar to that of the mop pad 80.

A fixing groove 88 may be formed in the center of the lower surface of the holder plate 82. The fixing groove 88 may be formed so that the fixing protrusion 83 of the pad holder 81′ of other mop pad assembly 80A′ is inserted thereinto.

A plurality of Velcro 84 may be disposed on the lower surface of the holder plate 82 at regular intervals. The plurality of Velcro 84 may be arranged in a circular around the fixing groove 88. Because the detachable surface is provided on the upper surface of the mop pad 80, the mop pad 80 may be fixed or attached to the lower surface of the holder plate 82 with the plurality of Velcro 84. When the mop pad 80 is attached to the lower surface of the holder plate 82, the mop pad assembly 80A′ is formed.

The fixing protrusion 83 may be formed to protrude from the center of the upper surface of the holder plate 82. The fixing groove 88 may be formed in the lower portion of the fixing protrusion 83. A separation magnet 89 may be disposed at the bottom of the fixing groove 88, that is, at the lower part of the fixing protrusion 83. The fixing protrusion 83 may be formed in a cylindrical shape. The separation magnet 89 may be formed of a permanent magnet.

The fixing protrusion 83 is formed to be held by the holder locker 52. In detail, the fixing protrusion 83 may be formed so that the fixing protrusion 83 is locked by the locking part of the holder locker 52. For example, a hooking groove 831 may be provided at the upper end portion of the fixing protrusion 83. The hooking groove 831 may be formed along the entire circumference of the outer circumferential surface of the fixing protrusion 83. The hooking groove 831 is formed so that the balls 531 of the plurality of ball springs 53 of the holder locker 52 are inserted thereinto.

The pad holder 81′ may be coupled to the holder locker 52 of the lifting plate 31 by the hooking groove 831 of the fixing protrusion 83. In detail, when the balls 531 of the plurality of ball springs 53 of the holder locker 52 are inserted into the hooking groove 831 of the fixing protrusion 83 of the pad holder 81′, the mop pad assembly 80A′ may be coupled to or caught in the holder locker 52.

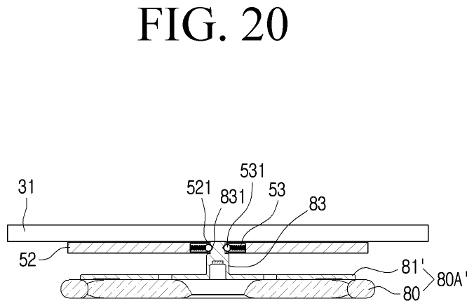

FIG. 20 is a cross-sectional view illustrating a state in which a pad holder 81′ of a mop pad assembly 80A′ is coupled to a holder locker 52 of a lifting plate 31 of a robot cleaner station 1′ according to one or more embodiments of the disclosure.

Referring to FIG. 20, the fixing protrusion 83 of the pad holder 81′ of the mop pad assembly 80A′ is inserted into the locking hole 521 of the holder locker 52 of the lifting plate 31. When the fixing protrusion 83 of the pad holder 81′ is inserted into the locking hole 521, the plurality of ball springs 53 are compressed by the fixing protrusion 83, so that the fixing protrusion 83 is inserted into the locking hole 521. When the fixing protrusion 83 of the pad holder 81′ is inserted into the locking hole 521 so that the hooking groove 831 of the fixing protrusion 83 is located in front of the plurality of ball springs 53, the plurality of balls 531 are inserted into the hooking groove 831 of the fixing protrusion 83. Accordingly, the mop pad assembly 80A′ is secured to the holder locker 52.

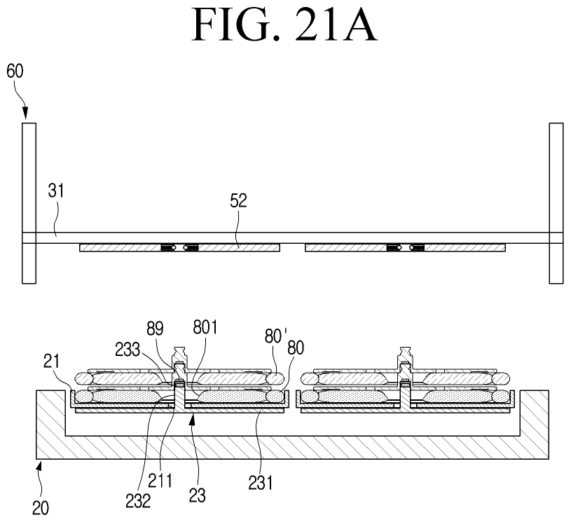

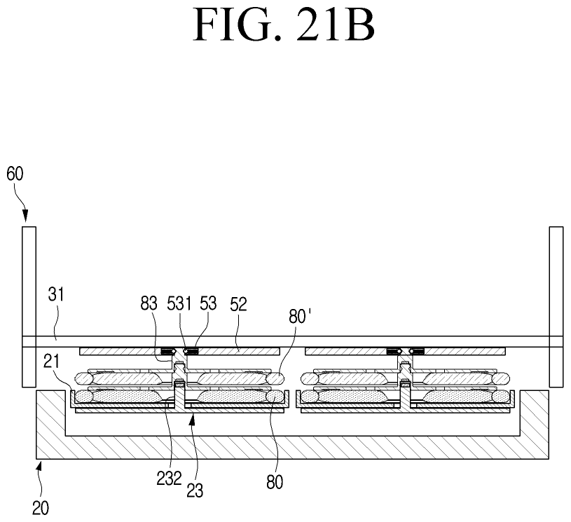

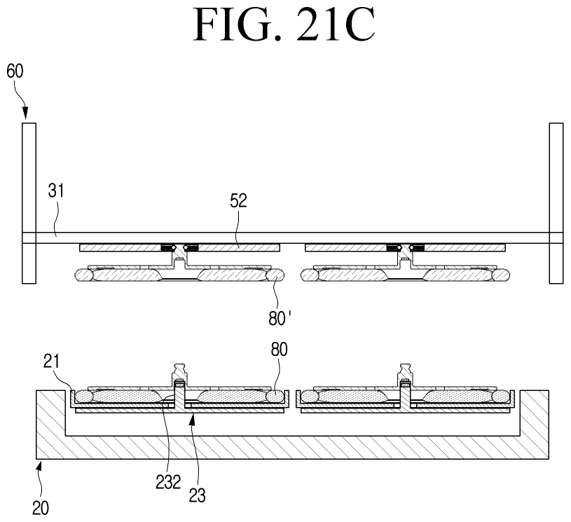

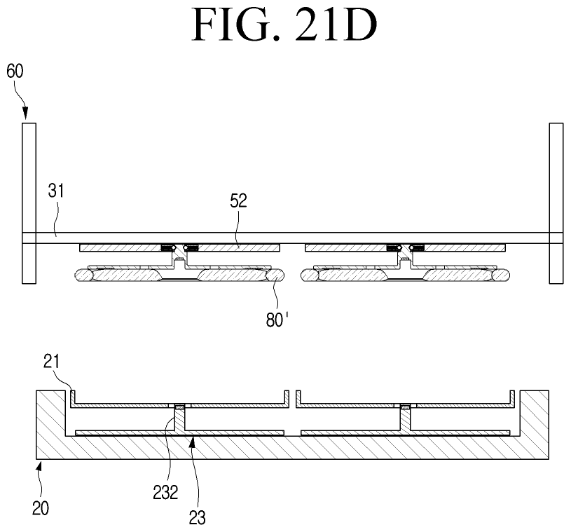

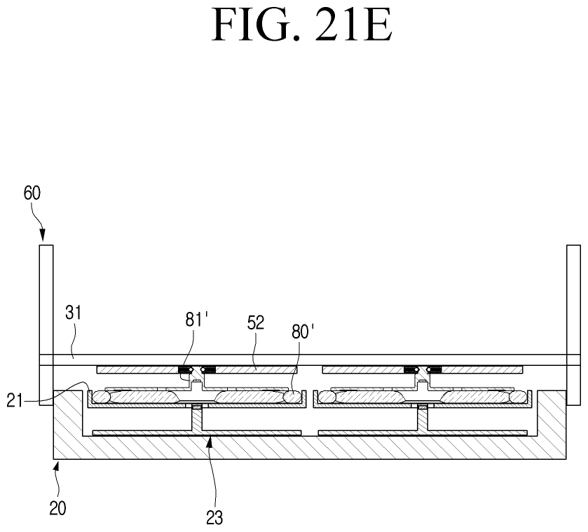

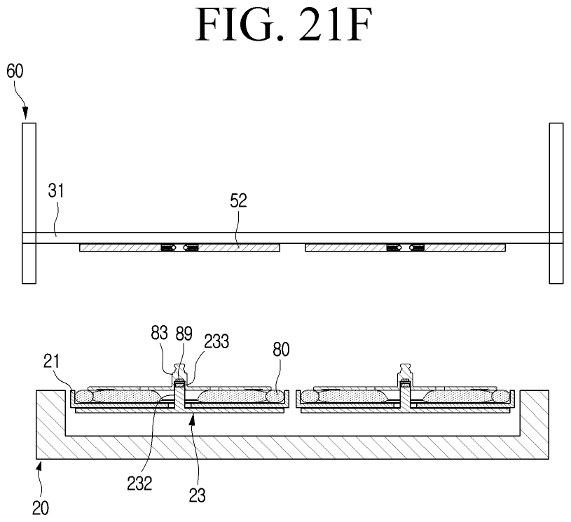

Hereinafter, a method of replacing a mop pad 80 of the robot cleaner system 200 including the robot cleaner station 1′ and the robot cleaner 100 will be described in detail with reference to FIGS. 21A, 21B, 21C, 21D, 21E, and 21F.

FIGS. 21A, 21B, 21C, 21D, 21E, and 21F are views for explaining a method of replacing a mop pad 80 using a robot cleaner system 200 according to one or more embodiments of the disclosure.

In the following description, for convenience of description, a mop pad assembly 80A′ including the mop pad 80 and the pad holder 81′ is referred to as the mop pad 80. That is, the used mop pad 80′ refers to the used mop pad assembly 80A′, and the cleaned mop pad 80 refers to the cleaned mop pad assembly 80A′.

After mopping, the robot cleaner 100 enters the robot cleaner station 1′ and is located on the upper surface of the base 10. At this time, the used mop pad 80′ mounted on the mopping device 104 of the robot cleaner 100 is positioned above the pad cleaner 20 of the base 10. At this time, the cleaned mop pad 80 is located in the pad seat 21 of the pad cleaner 20. Accordingly, the used mop pad 80′ mounted on the mopping device 104 of the robot cleaner 100 is positioned above the cleaned mop pad 80 placed on the pad cleaner 20 of the base 10.

The robot processor 109 controls the mop pad attaching and detaching device 105 to separate the used mop pad 80′ mounted on the mopping device 104. Then, as illustrated in FIG. 21A, the separated used mop pad 80′ is stacked on the cleaned mop pad 80 located in the pad cleaner 20.

FIG. 21A is a view illustrating a state in which the mop pad 80′ used by the robot cleaner 100 is stacked on the cleaned mop pad 80 placed on the pad seat 21 of the pad cleaner 20 of the robot cleaner station 1′.

Referring to FIG. 21A, the cleaned mop pad 80 and the used mop pad 80′ are stacked in the pad seat 21. That is, the used mop pad 80′ is located on the cleaned mop pad 80.

At this time, the pad fixing device 23 located below the pad seat 21 is located below the cleaned mop pad 80. In detail, the insertion protrusion 232 of the pad fixing device 23 is located at the insertion position. Accordingly, the cleaned mop pad 80 is fixed to the pad seat 21 by the pad fixing device 23, and the used mop pad 80′ is not fixed to the pad seat 21 by the pad fixing device 23.

The pad fixing device 23 may be configured to fix the mop pad 80 to the pad seat 21. The pad seat 21 includes a through hole 211 formed in the center of the pad seat 21. The pad fixing device 23 may include a moving plate 231 and an insertion protrusion 232 protruding from the center of the moving plate 231. The insertion protrusion 232 may be formed to be inserted into the through hole 211 of the pad seat 21. A metal piece 233 may be disposed on the top of the insertion protrusion 232.

The moving plate 231 is formed to move in the vertical direction. The insertion protrusion 232 may be positioned at one of the original position and the insertion position by the moving plate 231.

When the insertion protrusion 232 is located in the original position, the top of the insertion protrusion 232 is located below the cleaned mop pad 80, that is, at the same level as or below the upper surface of the pad seat 21. When the insertion protrusion 232 is located in the original position, the cleaned mop pad 80 is not fixed to the pad seat 21.

When the insertion protrusion 232 is located at the insertion position, the insertion protrusion 232 protrudes from the through hole 211 of the pad seat 21 and is inserted into the mop hole 801 of the cleaned mop pad 80, so that the top of the insertion protrusion 232 is adjacent to or contacts the separation magnet 89 provided in the fixing groove 88 of the pad holder 81. When the insertion protrusion 232 is located at the insertion position, the cleaned mop pad 80 is magnetically fixed to the pad seat 21.

In this state, the processor 90 controls the lifting device 60 to lower the lifting plate 31, thereby fixing the used mop pad 80′ to the holder locker 52 on the lower surface of the lifting plate 31. This state is shown in FIG. 21B.

FIG. 21B is a view illustrating a state in which the lifting plate 31 is lowered and the used mop pad 80′ placed on the cleaned mop pad 80 located in the pad seat 21 of the pad cleaner 20 is fixed with the holder locker 52.

Referring to FIG. 21B, the holder locker 52 disposed on the lower surface of the lifting plate 31 fixes the used mop pad 80′. In detail, when the lifting plate 31 is lowered to the lower position, the fixing protrusion 83 of the used mop pad 80′ is inserted into the locking hole 521 of the holder locker 52 disposed on the lower surface of the lifting plate 31. Then, the balls 531 of the plurality of ball springs 53 provided in the locking hole 521 are inserted into the hooking groove 831 of the fixing protrusion 83, so that the used mop pad 80′ is fixed to the holder locker 52 of the lifting plate 31.

At this time, the insertion protrusion 232 of the pad fixing device 23 is located at the insertion position, thereby fixing the cleaned mop pad 80 to the pad seat 21.

In this state, the processor 90 controls the lifting device 60 to raise the lifting plate 31 to the upper position. Then, the used mop pad 80′ fixed to the holder locker 52 of the lifting plate 31 moves to the upper position together with the lifting plate 31. This state is shown in FIG. 21C.

FIG. 21C is a view illustrating a state in which the lifting plate 31 is raised so that the used mop pad 80′ is positioned at the upper position.

Referring to FIG. 21C, the used mop pad 80′ fixed to the holder locker 52 on the lower surface of the lifting plate 31 is located at the upper position together with the lifting plate 31, and the cleaned mop pad 80 is placed on the pad seat 21 of the pad cleaner 20. At this time, the cleaned mop pad 80 is magnetically fixed to the pad seat 21 by the insertion protrusion 232 of the pad fixing device 23.

In this state, the processor 90 controls the pad fixing device 23 of the pad cleaner 20 to move the insertion protrusion 232 to its original position. Then, the insertion protrusion 232 is located below the pad seat 21, so that the cleaned mop pad 80 is not fixed to the pad seat 21.

In this state, the processor 90 may control the communication part 93 to transmit a mop pad preparation signal to the robot cleaner 100.

When the robot cleaner 100 receives the mop pad preparation signal from the robot cleaner station 1′, the robot cleaner 100 enters the robot cleaner station 1′ and mounts the cleaned mop pad 80 located on the pad seat 21 of the base 10 to itself.

In detail, when the robot processor 109 receives the mop pad preparation signal through the robot communication part 106, the robot processor 109 controls the moving device 101 to move the robot cleaner 100 to the base 10 of the robot cleaner station 1′.

When the robot cleaner 100 is located on the upper surface of the base 10, the mopping device 104 of the robot cleaner 100 is positioned above the pad seat 21 of the pad cleaner 20. Then, the robot processor 109 controls the mop pad attaching and detaching device 105 to mount the mop pad 80 placed on the pad seat 21 to the mopping device 104.

When mounting of the mop pad 80 is completed, the robot processor 109 controls the moving device 101 to move the robot cleaner 100 to the outside of the robot cleaner station 1′ and controls the robot communication part 106 to transmit a mop pad mounting signal to the robot cleaner station 1′.

After that, the robot processor 109 controls the robot cleaner 100 to mop the surface to be cleaned.

The state of the robot cleaner station 1′ after the robot cleaner 100 is equipped with the cleaned mop pad 80 and leaves the robot cleaner station 1′ is illustrated in FIG. 21D.

Referring to FIG. 21D, the used mop pad 80′ fixed to the holder locker 52 of the lifting plate 31 is located in the upper position, and there is no mop pad 80 in the pad cleaner 20. The insertion protrusion 232 of the pad fixing device 23 is located at or below the bottom of the pad seat 21.

Upon receiving the mop pad mounting signal from the robot cleaner 100, the processor 90 controls the lifting device 60 to lower the lifting plate 31 to the lower position.

When the lifting plate 31 is positioned in the lower position, the used mop pad 80′ is positioned in the pad seat 21 of the pad cleaner 20. In this state, the processor 90 controls the pad cleaner 20 to clean the used mop pad 80′. This state is shown in FIG. 21E.

FIG. 21E is a view illustrating a state in which the pad cleaner 20 cleans the used mop pad 80′ fixed to the lifting plate 31 located at the lower position.

Referring to FIG. 21E, when the pad cleaner 20 cleans the used mop pad 80′, the pad holder 81′ of the used mop pad 80′ is not coupled to the insertion protrusion 232 of the pad fixing device 23. That is, when the pad cleaner 20 cleans the used mop pad 80′, the insertion protrusion 232 of the pad fixing device 23 is located in its original position.

When cleaning of the used mop pad 80′ by the pad cleaner 20 is completed, the used mop pad 80′ becomes a cleaned mop pad 80.

When cleaning of the mop pad 80 is completed, the processor 90 controls the pad fixing device 23 to move the insertion protrusion 232 to the insertion position. Then, the insertion protrusion 232 passes through the mop hole 801 of the cleaned mop pad 80 and is inserted into the fixing groove 88 to be adjacent to or in contact with the separation magnet 89. Then, the cleaned mop pad 80 is fixed to the pad seat 21 by the magnetic force between the metal piece 233 of the insertion protrusion 232 and the separation magnet 89 of the fixing protrusion 83.

After that, the processor 90 controls the lifting device 60 to raise the lifting plate 31. When the lifting plate 31 is located at the upper position, the processor 90 controls a pad drying device 29 to dry the cleaned mop pad 80. This state is shown in FIG. 21F.

FIG. 21F is a view illustrating a state in which the cleaned mop pad 80 is fixed to the pad seat 21 of the pad cleaner 20.

In this embodiment, the pad cleaner 20 may include the pad drying device 29. The pad drying device 29 may be disposed below the pad seat 21. Accordingly, when the pad drying device 29 is operated by the processor 90, the cleaned mop pad 80 fixed to the pad seat 21 is dried. At this time, no mop pad 80 is fixed to the holder locker 52 of the lifting plate 31 located at the upper position.

The robot cleaner station 1 and 1′ according to one or more embodiments of the disclosure having the structure described above may clean the used mop pad while the robot cleaner performs mopping. Therefore, compared to the robot cleaner according to the prior art configured to clean the used mop pad while the used mop pad is attached to the robot cleaner, the robot cleaner station 1 and 1′ according to one or more embodiments of the disclosure takes sufficient time to clean the used mop pad, so that cleaning of the used mop pad may be done reliably.

In addition, the robot cleaner station 1 and 1′ according to one or more embodiments of the disclosure separates the used mop pad from the robot cleaner and then cleans the used mop pad, so the cleaned mop pad may be dried with hot air having high-temperature and chemically disinfected.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A robot cleaner station comprising:
a base;
a pad cleaner provided in an upper surface of the base and configured to place and clean a mop pad;
a pad moving device configured to move a used mop pad from the pad cleaner and place a cleaned mop pad on the pad cleaner; and
one or more processors,
wherein, by executing one or more instructions stored on at least one memory, the one or more processors are configured to:
control the pad moving device to move the used mop pad to the pad cleaner, and
control the pad cleaner to clean the used mop pad based on a robot cleaner obtaining the cleaned mop pad and moving away from the base.

2. The robot cleaner station of claim 1, wherein
the pad moving device comprises:
a lifting frame having a rectangular shape;
a rotating plate rotatably provided within the lifting frame and to which the mop pad is fixed;
a lifting device configured to move the lifting frame up and down; and
a rotating device configured to rotate the rotating plate.

3. The robot cleaner station of claim 2, wherein
the rotating plate comprises:
a first surface;
a second surface opposite to the first surface;
a first holder locker on the first surface and configured to selectively hold the mop pad; and
a second holder locker on the second surface and configured to selectively hold the mop pad.

4. The robot cleaner station of claim 2, wherein
the rotating device comprises:
a pair of protrusions respectively protruding from side surfaces of the rotating plate;
a pair of interference levers respectively provided on sides of the lifting frame, wherein, based on the lifting frame moving up and one of the pair of interference levers interfering with one of the pair of protrusions, the rotating plate rotates at a certain angle with respect to the lifting frame; and
two pairs of stop grooves respectively provided on the side surfaces of the lifting frame and configured to accommodate the pair of protrusions.

5. The robot cleaner station of claim 2, wherein
the lifting device comprises:
a pair of rack gears respectively provided on side surfaces of the lifting frame;
a pair of pinions engaged with the pair of rack gears;
a driving gear configured to drive the pair of pinions;
a motor to configured to rotate the driving gear; and
a pair of guiders configured to guide an up and down movement of the lifting frame.

6. The robot cleaner station of claim 5, wherein
the driving gear comprises:
a first driving gear and a second driving gear respectively engaged with the pair of pinions, and
a connection shaft connecting the first driving gear and the second driving gear.

7. The robot cleaner station of claim 1, wherein
the pad moving device comprises:
a lifting plate having a rectangular shape and to which the mop pad is fixed; and
a lifting device configured to move the lifting plate up and down.

8. The robot cleaner station of claim 7, wherein
the lifting device comprises:
a pair of rack gears respectively provided on side surfaces of the lifting plate;
a pair of pinions engaged with the pair of rack gears;
a driving gear configured to drive the pair of pinions;
a motor configured to rotate the driving gear; and
a pair of guiders configured to guide an up and down movement of the lifting plate.

9. The robot cleaner station of claim 7, wherein
the lifting plate comprises a holder locker on a lower surface configured to selectively hold the mop pad.

10. The robot cleaner station of claim 9, wherein
the holder locker comprises:
a locking hole in a center thereof; and
a plurality of ball springs provided at intervals on an inner circumferential surface of the locking hole.

11. The robot cleaner station of claim 1, wherein
the pad moving device comprises:
a pad holder configured to fix the mop pad; and
a holder locker configured to selectively hold the pad holder, and
wherein the pad holder comprises:
a holder plate having a lower surface to which the mop pad is attached; and
a fixing protrusion protruding from a center of an upper surface of the holder plate.

12. The robot cleaner station of claim 11, wherein
the holder locker comprises:
a locking hole at a center of the holder locker and into which the fixing protrusion of the pad holder is to be inserted; and
a lock included in the locking hole and configured to selectively fix the fixing protrusion.

13. A robot cleaner system comprising:
a robot cleaner configured to mop a surface using a cleaned mop pad; and
a robot cleaner station configured to:
supply the cleaned mop pad to the robot cleaner,
replace, based on a mopping operation of the robot cleaner being completed such that the cleaned mop pad becomes a used mop pad, the used mop pad with a second cleaned mop pad, and
clean the used mop pad based on the robot cleaner performing the mopping operation,
wherein the robot cleaner station comprises:
a base;
a pad cleaner provided in an upper surface of the base and configured to place the cleaned mop pad and clean the used mop pad;
a pad moving device configured to move the used mop pad from the pad cleaner and place the cleaned mop pad on the pad cleaner; and
one or more processors,
wherein, by executing one or more instructions stored on at least one memory, the one or more processors are configured to:
control the pad moving device to move the used mop pad to the pad cleaner, and
control the pad cleaner to clean the used mop pad based on the robot cleaner obtaining the cleaned mop pad and leaving the base to perform the mopping operation.

14. The robot cleaner system of claim 13, wherein
the pad moving device comprises:
a lifting frame having a rectangular shape;
a rotating plate rotatably provided within the lifting frame and configured to fix the used mop pad and the cleaned mop pad; and
a lifting device configured to move the lifting frame up and down; and
a rotating device configured to rotate the rotating plate.

15. The robot cleaner system of claim 13, wherein
the pad moving device comprises:
a lifting plate having a rectangular shape and configured to fix the used mop pad; and
a lifting device configured to move the lifting plate up and down.

16. The robot cleaner system of claim 14, wherein
the rotating device comprises:
a pair of protrusions respectively protruding from side surfaces of the rotating plate;
a pair of interference levers respectively provided on both sides of the lifting frame, wherein, based on the lifting frame moving up and one of the pair of interference levers contacting one of the pair of protrusions, the rotating plate rotates at a certain angle with respect to the lifting frame; and
two pairs of stop grooves respectively provided on the side surfaces of the lifting frame and configured to accommodate the pair of protrusions.

17. The robot cleaner system of claim 14, further comprising a dryer on an upper side of the lifting frame configured to dry the cleaned mop pad.

18. A robot cleaner system comprising:
a pad cleaner provided in an upper surface of a base and configured to place and clean a mop pad;
a pad moving device configured to move a used mop pad to the pad cleaner,
wherein the pad moving device comprises:
a lifting frame comprising a pair of interference levers respectively provided on sides thereof, and two pairs of stop grooves respectively provided on side surfaces thereof;
a rotating plate rotatably provided within the lifting frame and comprising a pair of protrusions respectively protruding from side surfaces thereof and corresponding to the two pairs of stop grooves of the lifting frame; and
a lifting device configured to move the lifting frame up and down,
wherein, based on the lifting frame being moved up and one of the pair of interference levers interfering with one of the pair of protrusions, the rotating plate rotates a certain angle with respect to the lifting frame, and
wherein, based on the lifting frame being moved down, the rotating plate does not rotate.

19. The robot cleaner system of claim 18, further comprising one or more processors,
wherein, by executing one or more instructions stored on at least one memory, the one or more processors are configured to:
control the pad moving device to move a used mop pad to the pad cleaner, and
control the pad cleaner to clean the used mop pad.

20. The robot cleaner system of claim 18, wherein
the rotating plate comprises:
a first surface;
a second surface opposite to the first surface;
a first holder locker on the first surface and configured to selectively hold the mop pad; and
a second holder locker on the second surface and configured to selectively hold the mop pad.
